(19) United States
(12) Patent Application Publication
(10) Pub. No.: US 2020/0234123 A1
(43) Pub. Date: Jul. 23, 2020

(54) REINFORCEMENT LEARNING METHOD, RECORDING MEDIUM, AND REINFORCEMENT LEARNING APPARATUS

(71) Applicant: FUJITSU LIMITED, Kawasaki-shi (JP)

(72) Inventors: Junichi Shigezumi, Kawasaki (JP); Hidenao Iwane, Kawasaki (JP); Hitoshi Yanami, Kawasaki (JP)

(73) Assignee: FUJITSU LIMITED, Kawasaki-shi (JP)

(21) Appl. No.: 16/744,948

(22) Filed: Jan. 16, 2020

(30) Foreign Application Priority Data
Jan. 22, 2019 (JP) 2019-008512

(51) Int. Cl. G06N 3/08; G05B 13/02; G06N 20/00

(52) U.S. Cl. CPC G06N 3/08; G06N 20/00; G05B 13/0265

(57) ABSTRACT

A reinforcement learning method executed by a computer includes calculating, in reinforcement learning of repeatedly executing a learning step for a value function that has monotonicity as a characteristic of a value according to a state or an action of a control target, a contribution level of the state or the action of the control target used in the learning step, the contribution level of the state or the action to the reinforcement learning being calculated for each learning step and calculated using a basis function used for representing the value function; determining whether to update the value function, based on the value function after each learning step and the calculated contribution level calculated in each learning step; and updating the value function when the determining determines to update the value function.

### CROSS REFERENCE TO RELATED APPLICATIONS

This application is based upon and claims the benefit of priority of the prior Japanese Patent Application No. 2019-008512, filed on Jan. 22, 2019, the entire contents of which are incorporated herein by reference.

### FIELD

Embodiments discussed herein relate to a reinforcement learning method, a recording medium, and a reinforcement learning apparatus.

### BACKGROUND

Conventionally, in the field of reinforcement learning, for example, an environment is controlled by repeatedly performing a series of processes learned by a controller for determining a policy judged to be optimal as an action to the environment, based on a reward observed from the environment in response to the action performed to the environment.

In a conventional technique, for example, for each different range in a wireless communication network and according to a common value function that determines an action value for each optimization process according to a state variable, any of multiple optimization processes is selected and executed according to the state variable within the range. In another technique, for example, by using a value function, an action of an investigated target at a prediction time is decided from a state at the prediction time as position information of the investigated target at the prediction time. In another technique, for example, a value function defining a value of a work extracting operation is updated according to a reward calculated based on a judgment result of success/failure of work extraction by a robot. For examples, refer to Japanese Laid-Open Patent Publication No. 2013-106202, Japanese Laid-Open Patent Publication No. 2017-168029, and Japanese Laid-Open Patent Publication No. 2017-064910.

### SUMMARY

According to an aspect of an embodiment, a reinforcement learning method executed by a computer includes calculating, in reinforcement learning of repeatedly executing a unit learning step in learning a value function that has monotonicity as a characteristic of a value for a state or an action of a control target, a contribution level of the state or the action of the control target used in the unit learning step, the contribution level of the state or the action to the reinforcement learning being calculated for each execution of the unit learning step and calculated using a basis function used for representing the value function; determining whether to update the value function, based on the value function after the unit learning step and the calculated contribution level; and updating the value function when determining to update the value function.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of a reinforcement learning method according to an embodiment.

FIG. 2 is a block diagram of an example of a hardware configuration of a reinforcement learning apparatus 100.

FIG. 3 is a block diagram depicting an example of a functional configuration of the reinforcement learning apparatus 100.

FIG. 4 is a block diagram depicting a specific example of a functional configuration of the reinforcement learning apparatus 100.

FIG. 5 is an explanatory diagram depicting a definition example of a value function.

FIG. 6 is an explanatory diagram depicting a first operation example of the reinforcement learning apparatus 100.

FIG. 7 is a flowchart of an example of a learning process procedure in the first operation example.

FIG. 8 is a flowchart depicting an example of a learning process procedure in a second operation example.

FIG. 9 is a flowchart depicting an example of the learning process procedure in the second operation example.

FIG. 10 is a flowchart depicting an example of a learning process procedure in a third operation example.

FIG. 11 is a flowchart depicting an example of the learning process procedure in the third operation example.

FIG. 12 is a flowchart depicting an example of a learning process procedure in a fourth operation example.

FIG. 13 is a flowchart depicting an example of the learning process procedure in the fourth operation example.

FIG. 14 is an explanatory diagram depicting a fifth operation example of the reinforcement learning apparatus 100.

FIG. 15 is a flowchart depicting an example of a learning process procedure in the fifth operation example.

FIG. 16 is a flowchart depicting an example of the learning process procedure in the fifth operation example.

FIG. 17 is an explanatory diagram depicting an example of comparison of the learning efficiency through reinforcement learning.

FIG. 18 is an explanatory diagram depicting an example of comparison of the learning efficiency through reinforcement learning.

FIG. 19 is an explanatory diagram depicting an example of comparison of the learning efficiency through reinforcement learning.

FIG. 20 is an explanatory diagram depicting another example of comparison of the learning efficiency through reinforcement learning.

FIG. 21 is an explanatory diagram depicting another example of comparison of the learning efficiency through reinforcement learning.

FIG. 22 is an explanatory diagram depicting another example of comparison of the learning efficiency through reinforcement learning.

### DESCRIPTION OF THE INVENTION

Embodiments of a reinforcement learning method, a recording medium, and a reinforcement learning apparatus will be described with reference to the accompanying drawings.

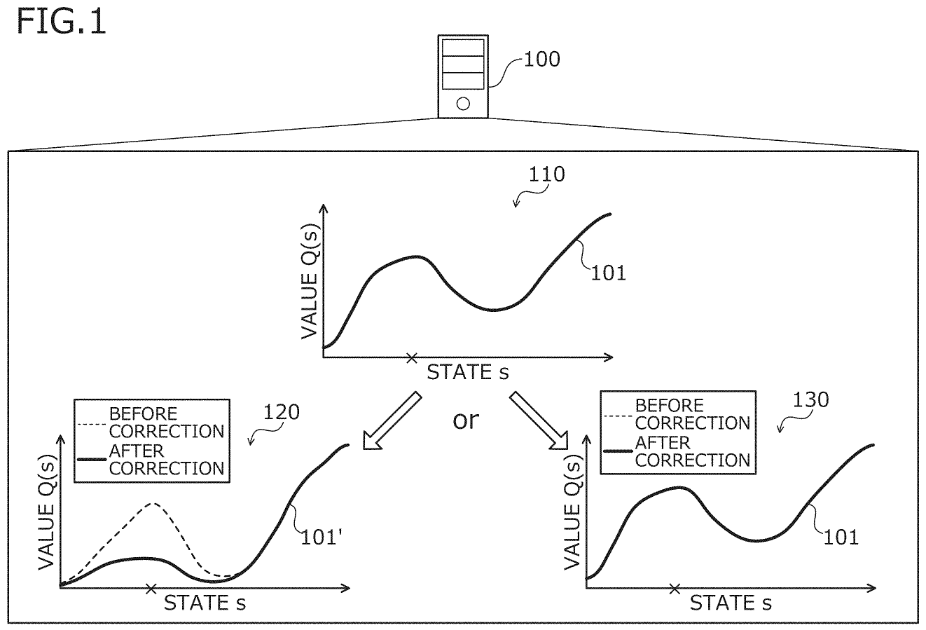

FIG. 1 is an explanatory diagram of an example of a reinforcement learning method according to the embodiment. A reinforcement learning apparatus 100 is a computer for controlling a control target by reinforcement learning. The reinforcement learning apparatus 100 is a server, a personal computer (PC), or a microcontroller, for example.

The control target is any event/matter, for example, a physical system that actually exists. The control target is also referred to as an environment. For example, the control target is an automobile, a robot, a drone, a helicopter, a server room, a generator, a chemical plant, or a game.

In reinforcement learning, for example, an exploratory action on a control target is decided, and the control target is controlled by repeating a series of processes of learning a value function based on a state of the control target, the decided exploratory action, and a reward of the control target observed according to the determined exploratory action. For the reinforcement learning, for example, Q learning, SARSA, or actor-critic is utilized.

The value function is a function defining a value of an action on the control target. The value function is, for example, a state action value function or a state value function. An action is also referred to as an input. The action is, for example, a continuous amount. A state of the control target changes according to the action on the control target. The state of the control target may be observed.

An improvement in learning efficiency through reinforcement learning is desired in some cases. For example, when the reinforcement learning is utilized for controlling a control target that actually exists rather than on a simulator, learning of an accurate value function is required even at an initial stage of the reinforcement learning, which leads to a tendency to desire an improvement in learning efficiency through reinforcement learning.

However, it is conventionally difficult to improve learning efficiency through reinforcement learning. For example, it is difficult to obtain an accurate value function unless various actions are tried for various states, which leads to an increase in processing time for the reinforcement learning. Particularly, when reinforcement learning is to be used for controlling a control target that actually exists, it is difficult to arbitrarily change the state of the control target, which makes it difficult to try various actions for various states.

In this regard, a conceivable technique may utilize characteristics of the value function resulting from a property of the control target to facilitate an improvement in learning efficiency through reinforcement learning. For example, the characteristics of the value function may have monotonicity with respect to a value for the state or action of the control target. In a technique conceivable in this case, the learning efficiency is improved through reinforcement learning by utilizing the monotonicity to further update the value function each time the value function is learned in the process of the reinforcement learning.

Even with such a method, it is difficult to efficiently learn the value function. For example, as a result of utilizing the monotonicity to further update the value function each time the value function is learned in the process of the reinforcement learning, an error of the value function increases, whereby the learning efficiency through reinforcement learning may be reduced instead.

Conventionally, an accurate value function is difficult to obtain in an initial stage of reinforcement learning when actions have been tried only for a relatively small number of states and thus, various actions have not been tried for various states. In the initial stage of reinforcement learning, since the number of trials is small and the number of combinations of learned states and actions is small, learning hardly advances with respect to a state for which no action has been tried, whereby an error becomes larger. Additionally, due to a bias of states for which actions have already been tried, learning is performed via a state not satisfying the monotonicity, thereby slowing the progress of the reinforcement learning and resulting in deterioration in learning efficiency.

If reinforcement learning is to be utilized for controlling a real-world control target, the reinforcement learning must have not only the accuracy of learning results but also the efficiency under restrictions of learning time and resources required for learning. To control the real-world control target in the real world, appropriate control is required even in the initial stage of the reinforcement learning. In this regard, conventionally, the reinforcement learning is developed for research purposes in some cases, and reinforcement learning techniques tend to be developed with the goals of improving the convergence speed to an optimal solution or theoretically assuring convergence to an optimal solution in a situation where a relatively large number of combinations exist between states to be learned and actions. The reinforcement learning techniques developed for research purposes do not aim to improve the learning efficiency in the initial stage of reinforcement learning and therefore, are not necessarily preferable for use in controlling a real-world control target. For the reinforcement learning techniques developed for research purposes, it is difficult to appropriately control the control target in the initial stage of the reinforcement learning, whereby it tends to be difficult to obtain an accurate value function.

Therefore, in this embodiment, description will be made of a reinforcement learning method capable of improving the learning efficiency through reinforcement learning by utilizing characteristics of a value function to determine whether to update the value function before updating the value function each time the value function is learned in the process of the reinforcement learning.

In FIG. 1, the reinforcement learning apparatus 100 implements reinforcement learning. In the reinforcement learning, a series of processes of learning a value function is repeated to control a control target. In the following description, a series of processes of learning a value function may be referred to as a “unit learning step”. The value function is represented by using a basis function, for example.

The value function has, for example, monotonicity in a characteristic of a value for a state or action of the control target. For example, the monotonicity is monotonic increase. For example, the monotonic increase is a property in which a magnitude of a variable representing a value increases as a magnitude of a variable representing the state or action of the control target increases. For example, the monotonicity may be monotonic decrease. For example, the monotonicity may be monomodality.

For example, the value function has the monotonicity as a characteristic in a true state. The true state is an ideal state corresponding to the state learned an infinite number of times through reinforcement learning. On the other hand, for example, the value function may not have the monotonicity as a characteristic in an estimated state in a range of the state of an action of the control target. The estimated state is a state when the number of times of learning through reinforcement learning is relatively small. A value function closer to the true state is considered to be more accurate.

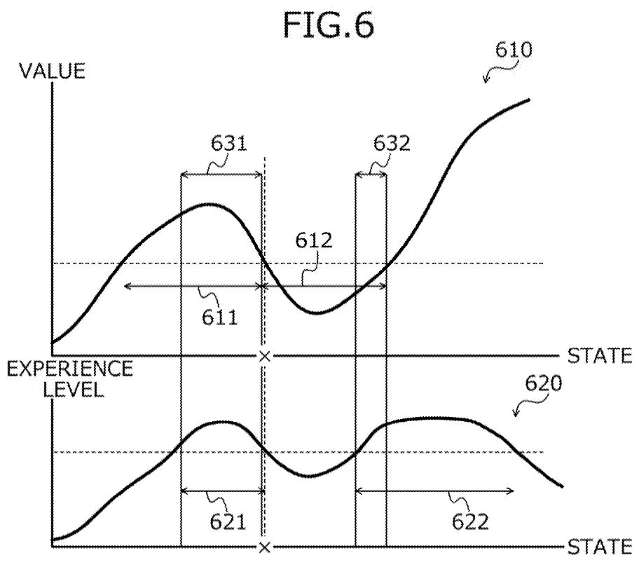

In the example in FIG. 1, (1-1) the reinforcement learning apparatus 100 calculates a contribution level of the state or action of the control target used in the unit learning step to the reinforcement learning by using a basis function for each unit learning step. For example, the reinforcement learning apparatus 100 calculates a result of substituting the state and action of the control target used in the unit learning step into the basis function as the contribution level of the state or action of the control target used in the unit learning step. An example of calculation of the contribution level will be described in detail later in first to fifth operation examples with reference to FIGS. 6 to 16.

(1-2) The reinforcement learning apparatus 100 determines whether to update the value function based on the value function after the unit learning step and the calculated contribution level. For example, the reinforcement learning apparatus 100 determines whether to update the value function for each unit learning step based on the value function learned in the current unit learning step and the calculated contribution level. In the example of FIG. 1, for example, the value function learned in the current unit learning step is a value function 101 depicted in a graph 110. The graph 110 includes “x”, which is the state used for the current unit learning step. In this case, for example, the reinforcement learning apparatus 100 determines whether to update the value function by correcting a portion corresponding to “x” in the value function in consideration of monotonicity. An example of determining whether to update the value function will be described later in the first to fifth operation examples with reference to FIGS. 6 to 16, for example.

(1-3) When determining that the value function is to be updated, the reinforcement learning apparatus 100 updates the value function based on the monotonicity. For example, when determining that the value function is to be updated for each unit learning step, the reinforcement learning apparatus 100 updates the value function based on the value function learned in the current unit learning step. In the example in FIG. 1, for example, when determining that the value function is to be updated 101, the reinforcement learning apparatus 100 corrects the value function 101 to reduce a value corresponding to “x” with consideration of monotonicity and thereby updates the value function 101 to a value function 101′. For example, when determining that the value function is not to be updated 101, the reinforcement learning apparatus 100 does not update the value function 101. An example of updating the value function will be described later in the first to fifth operation examples with reference to FIGS. 6 to 16, for example.

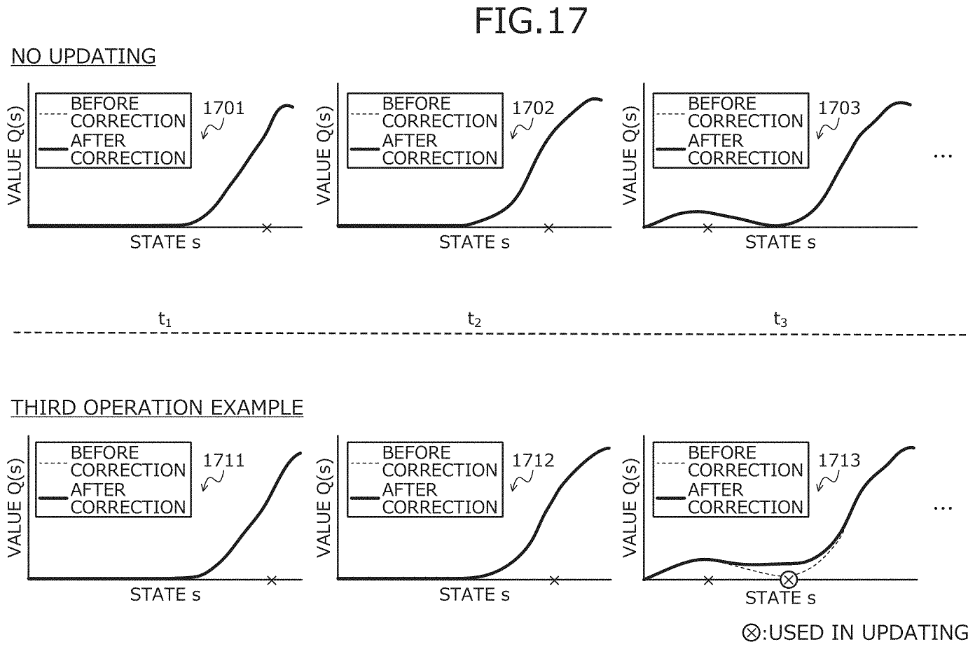

As a result, the reinforcement learning apparatus 100 may achieve an improvement in learning efficiency through reinforcement learning. For example, even in an initial stage of the reinforcement learning when actions have been tried only for a relatively small number of states and thus, various actions have not been tried for various states, the reinforcement learning apparatus 100 may facilitate acquisition of an accurate value function. Therefore, the reinforcement learning apparatus 100 may reduce the processing time required for the reinforcement learning. Additionally, the reinforcement learning apparatus 100 determines the necessity of updating of the value function and therefore, may prevent an update that increases an error of the value function. An example of learning efficiency will be described later with reference to FIGS. 17 to 22, for example.

Conventionally, in the initial stage of reinforcement learning, since the number of trials is small, and the number of combinations of learned states and actions is small, learning is hardly advanced with respect to a state for which no action has been tried, whereby an error becomes larger. Additionally, due to a bias of states for which actions have already been tried, learning is performed via a state not satisfying the monotonicity, thereby slowing the progress of the reinforcement learning and resulting in deterioration in learning efficiency. In this regard, even in the initial stage of the reinforcement learning when actions have been tried only for a relatively small number of states and thus, various actions have not been tried for various states, the reinforcement learning apparatus 100 may facilitate acquisition of an accurate value function. Additionally, even when the states are biased in terms of whether actions have already been tried, the reinforcement learning apparatus 100 may update the value function to suppress the learning via a state not satisfying the monotonicity. Furthermore, the reinforcement learning apparatus 100 may determine the necessity of updating the value function based on the contribution level with consideration of the number of trials and may prevent an update that increases an error of the value function.

Conventionally, reinforcement learning is developed for research purposes in some cases, and reinforcement learning techniques tend to be developed with the goals of improving the convergence speed to an optimal solution or theoretically assuring convergence to an optimal solution in a situation where a relatively large number of combinations exist between states to be learned and actions. For the reinforcement learning techniques developed for research purposes, it is difficult to appropriately control the control target in the initial stage of the reinforcement learning and thus, it tends to be difficult to obtain an accurate value function. In this regard, even in the initial stage of the reinforcement learning when actions are tried only for a relatively small number of states so that various actions are not tried for various states, the reinforcement learning apparatus 100 may facilitate acquisition of an accurate value function. Therefore, the reinforcement learning apparatus 100 may facilitate appropriate control of the control target by using the value function.

In a technique of always updating the value function by using the monotonicity each time the value function is learned in the process of the reinforcement learning described above, for example, the value function 101 is always updated to the value function 101′. In this case, the correction is made even if the portion corresponding to “x” in the value function is a portion accurately learned through a number of actions tried in the past, which results in a reduction in accuracy.

In particular, when the number of combinations of learned states and actions is small, the accuracy of the value function is likely to be reduced. For example, when the number of combinations of learned states and actions is small, and a concave portion to the right of “x” in the value function is a portion for which learning is still low, a portion that corresponds to “x” and for which learning is high is corrected according to the concave portion for which learning is lower, thereby resulting in a reduction in the accuracy of the value function. In this regard, the reinforcement learning apparatus 100 determines the necessity of updating the value function and therefore, may prevent an update that increases the error of the value function and suppresses reductions in the accuracy of the value function.

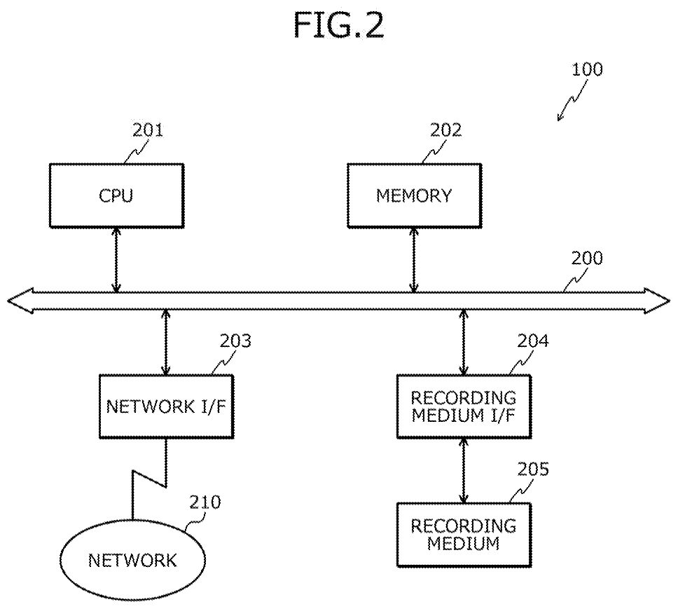

An example of a hardware configuration of the reinforcement learning apparatus 100 will be described using FIG. 2.

FIG. 2 is a block diagram of an example of a hardware configuration of the reinforcement learning apparatus 100. In FIG. 2, the reinforcement learning apparatus 100 has a central processing unit (CPU) 201, a memory 202, a network interface (I/F) 203, a recording medium I/F 204, and a recording medium 205. Further, components are connected by a bus 200.

Here, the CPU 201 governs overall control of the reinforcement learning apparatus 100. The memory 202, for example, has a read only memory (ROM), a random access memory (RAM) and a flash ROM. In particular, for example, the flash ROM and the ROM store various types of programs and the RAM is used as work area of the CPU 201. The programs stored by the memory 202 are loaded onto the CPU 201, whereby encoded processes are executed by the CPU 201.

The network I/F 203 is connected to a network 210 through a communications line and is connected to other computers via the network 210. The network I/F 203 further administers an internal interface with the network 210 and controls the input and output of data with respect to other computers. The network I/F 203, for example, is a modem, a local area network (LAN) adapter, etc.

The recording medium I/F 204, under the control of the CPU 201, controls the reading and writing of data with respect to the recording medium 205. The recording medium I/F 204, for example, is a disk drive, a solid state drive (SSD), a universal serial bus (USB) port, etc. The recording medium 205 is a non-volatile memory storing therein data written thereto under the control of the recording medium I/F 204. The recording medium 205, for example, is a disk, a semiconductor memory, a USB memory, etc. The recording medium 205 may be removable from the reinforcement learning apparatus 100.

In addition to the components above, the reinforcement learning apparatus 100, for example, may have a keyboard, a mouse, a display, a printer, a scanner, a microphone, a speaker, etc. Further, the reinforcement learning apparatus 100 may have the recording medium I/F 204 and/or the recording medium 205 in plural. Further, the reinforcement learning apparatus 100 may omit the recording medium I/F 204 and/or the recording medium 205.

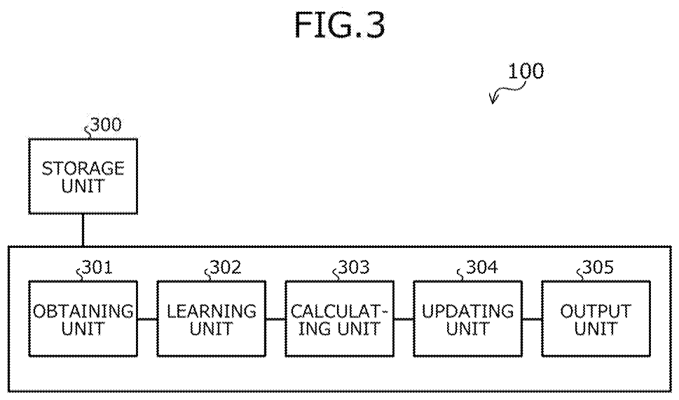

An example of a functional configuration of the reinforcement learning apparatus 100 will be described with reference to FIG. 3.

FIG. 3 is a block diagram depicting an example of a functional configuration of the reinforcement learning apparatus 100. The reinforcement learning apparatus 100 includes a storage unit 300, an obtaining unit 301, a learning unit 302, a calculating unit 303, an updating unit 304, and an output unit 305.

The storage unit 300 is implemented by storage areas of the memory 202, the recording medium 205, etc. depicted in FIG. 2. Although the storage unit 300 is included in the reinforcement learning apparatus 100 in the following description, the present invention is not limited hereto. For example, the storage unit 300 may be included in an apparatus different from the reinforcement learning apparatus 100 so that storage contents of the storage unit 300 may be referred to from the reinforcement learning apparatus 100.

The obtaining unit 301 to the output unit 305 function as an example of a control unit. For example, functions of the obtaining unit 301 to the output unit 305 are implemented by executing on the CPU 201, programs stored in the storage areas of the memory 202, the recording medium 205, etc. depicted in FIG. 2, or by the network I/F 203. Process results of the functional units are stored to the storage areas of the memory 202, the recording medium 205, etc. depicted in FIG. 2, for example.

The storage unit 300 is referred to in the processes of the functional units or stores various types of information to be updated. The storage unit 300 accumulates states of the control target, actions on the control target, and rewards of the control target. The storage unit 300 may accumulate costs of the control target instead of the rewards in some cases. In the case described as an example in the following description, the storage unit 300 accumulates the rewards. As a result, the storage unit 300 may enable the functional units to refer to the state, the action, and the reward.

For example, the control target may be a power generation facility. The power generation facility is, for example, a wind power generation facility. In this case, the action is, for example, a generator torque of the power generation facility. The state is, for example, at least one of a power generation amount of the power generation facility, a rotation amount of a turbine of the power generation facility, a rotational speed of the turbine of the power generation facility, a wind direction with respect to the power generation facility, and a wind speed with respect to the power generation facility. The reward is, for example, a power generation amount of the power generation facility.

For example, the control target may be an industrial robot. In this case, the action is, for example, a motor torque of the industrial robot. The state is, for example, at least one of an image taken by the industrial robot, a joint position of the industrial robot, a joint angle of the industrial robot, and a joint angular speed of the industrial robot. The reward is, for example, an amount of production of products of the industrial robot. The production amount is, for example, a number of assemblies. The number of assemblies is, for example, the number of products assembled by the industrial robot.

For example, the control target may be an air conditioning facility. In this case, the action is, for example, at least one of a set temperature of the air conditioning facility and a set air volume of the air conditioning facility. The state is, for example, at least one of a temperature inside a room with the air conditioning facility, a temperature outside the room with the air conditioning facility, and weather. The cost is, for example, power consumption of the air conditioning facility.

The storage unit 300 stores a value function. The value function is a function for calculating a value indicative of the value of the action. The value function is a state action value function or a state value function, for example. The value function is represented by using a basis function, for example. The value function has monotonicity in the characteristic of the value for the state or action of the control target, for example. The monotonicity is monotonic increase, for example. The monotonicity may be monotonic decrease or monomodality, for example. The storage unit 300 stores a basis function representative of the value function and a weight applied to the basis function, for example. The weight is wₖ described later. As a result, the storage unit 300 can enable the functional units to refer to the value function.

The storage unit 300 stores the control law for controlling the control target. The control law is, for example, a rule for deciding an action. For example, the control law is used for deciding an optimal action determined as being currently optimal. The storage unit 300 stores, for example, a parameter of the control law. The control law is also called a policy. As a result, the storage unit 300 enables determination of the action.

The obtaining unit 301 obtains various types of information used for the processes of the functional units. The various types of obtained information are stored to the storage unit 300 or output to the functional units by the obtaining unit 301. The obtaining unit 301 may output the various types of information stored to the storage unit 300 to the functional units. The obtaining unit 301 obtains various types of information based on a user operation input, for example. The obtaining unit 301 may receive various types of information from an apparatus different from the reinforcement learning apparatus 100, for example.

The obtaining unit 301 obtains the state of the control target and the reward of the control target in response to an action. For example, the obtaining unit 301 obtains and outputs to the storage unit 300, the state of the control target and the reward of the control target in response to an action. As a result, the obtaining unit 301 may cause the storage unit 300 to accumulate the states of the control target and the rewards of the control target in response to an action.

The learning unit 302 learns the value function. In reinforcement learning, for example, a unit learning step of learning the value function is repeated. For example, the learning unit 302 learns the value function through the unit learning step. For example, in the unit learning step, the learning unit 302 decides an exploratory action corresponding to the current state and updates the weight applied to the basis function representative of the value function, based on the reward corresponding to the exploratory action. For example, the exploratory action is decided by using a ε-greedy method or Boltzmann selection. For example, the learning unit 302 updates the weight applied to the basis function representative of the value function as in the first to fifth operation examples described later with reference to FIGS. 6 to 16. As a result, the learning unit 302 may improve the accuracy of the value function.

The calculating unit 303 uses the basis function used for representing the value function and calculates for each unit learning step, a contribution level to the reinforcement learning of the state or action of the control target used in the unit learning step. For example, the calculating unit 303 calculates a result of substituting the state and action used in the unit learning step into the basis function as the contribution level of the state or action used in the unit learning step.

The calculating unit 303 calculates for each unit learning step, an experience level in the reinforcement learning of the state or action used in the unit learning step, based on the calculated contribution level. The experience level indicates how many trials have been made for a state or action in the reinforcement learning. Therefore, the experience level indicates a degree of reliability of a portion of the value function related to a state or action. The calculating unit 303 also calculates an experience level of another state or action different from the state or action used in the unit learning step.

For example, the calculating unit 303 updates for each state or action of the control target, an experience level function that defines by the basis function, the experience level in the reinforcement learning. For example, the calculating unit 303 calculates a result of substituting the state and action used in the unit learning step into the experience level function as the experience level of the state or action used in the unit learning step. For example, the calculating unit 303 calculates the experience level of another state or action in the same way. For example, the calculating unit 303 updates the experience level function and calculates the experience level as in the first to fifth operation examples described later with reference to FIGS. 6 to 16. As a result, the calculating unit 303 may enable the updating unit 304 to refer to the information used as an index for determining whether to update the value function.

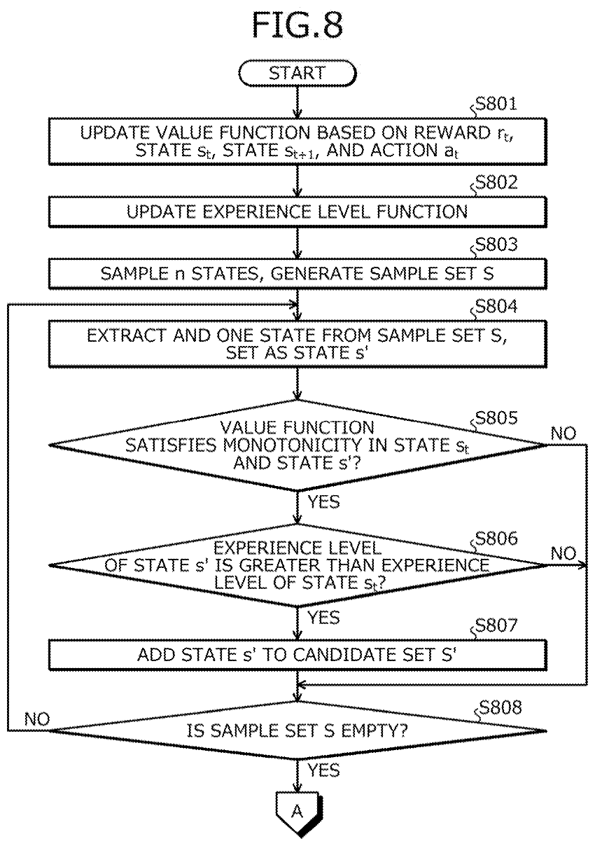

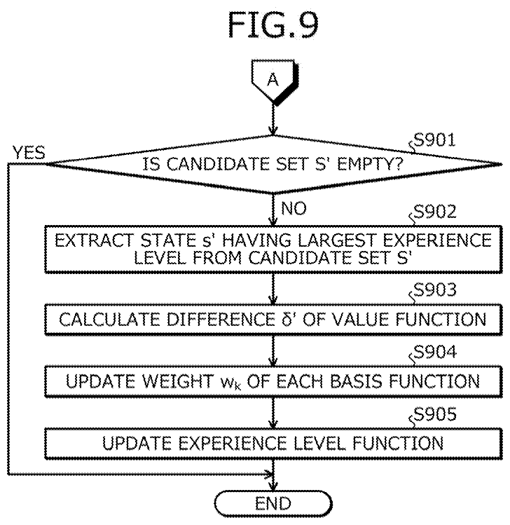

For example, when the updating unit 304 determines that the value function is to be updated, the calculating unit 303 may further update the experience level function such that the state or action used in the unit learning step is increased in the experience level. For example, the calculating unit 303 updates the experience level function as in the second operation example described later with reference to FIGS. 8 and 9. As a result, the calculating unit 303 may improve the accuracy of the experience level degree function.

The updating unit 304 determines whether to update the value function. For example, the updating unit 304 determines whether to update the value function, based on the value function after the unit learning step and the calculated contribution level. For example, the updating unit 304 determines whether to update the value function, based on the value function after the unit learning step and the experience level function updated based on the calculated contribution level. For example, the updating unit 304 determines whether to update the value function, based on the experience level of the state or action used in the unit learning step and the experience level of another state or action.

For example, the updating unit 304 determines whether the experience level of the state or action used in the unit learning step is smaller than the experience level of another state or action. The updating unit 304 also determines whether the monotonicity is satisfied between the state or action used in the unit learning step and another state or action. If the experience level of the state or action used in the unit learning step is smaller than the experience level of another state or action and the monotonicity is not satisfied, the updating unit 304 determines that the value function is to be updated in a portion corresponding to the state or action used in the unit learning step. For example, the updating unit 304 determines whether to update the value function as in the first to third operation examples described later with reference to FIGS. 6 to 11.

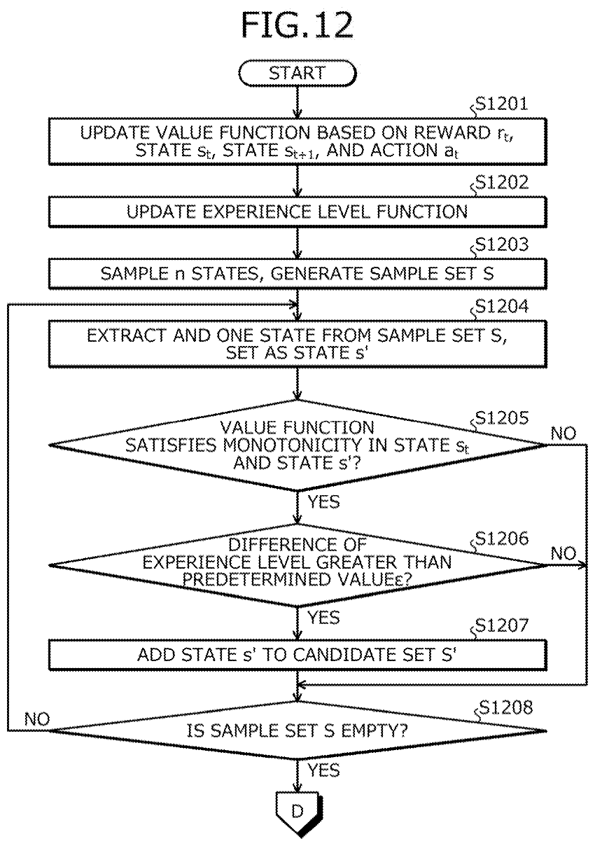

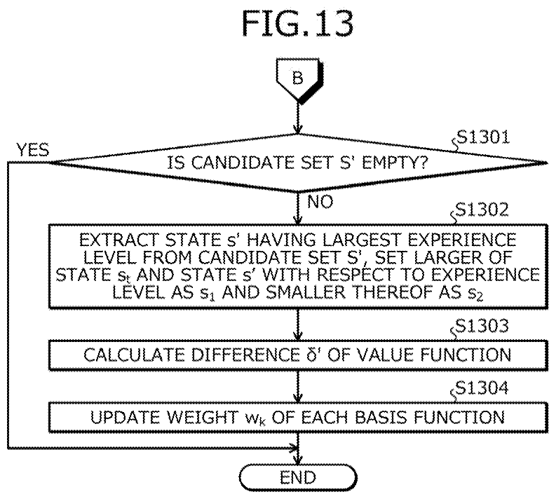

For example, if the experience level of the state or action used in the unit learning step is equal to or greater than the experience level of another state or action and the monotonicity is not satisfied, the updating unit 304 may determine that the value function is to be updated in a portion corresponding to the state or action used in the unit learning step. For example, the updating unit 304 determines whether to update the value function as in the fourth operation example described later with reference to FIGS. 12 and 13.

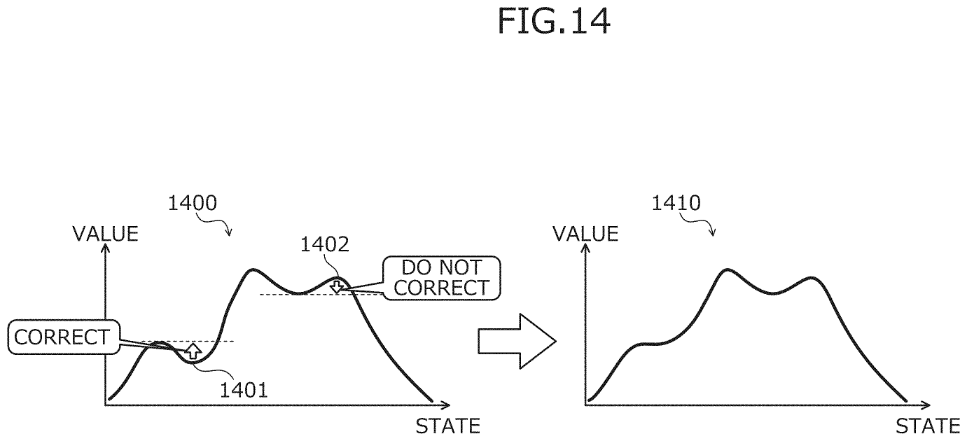

For example, the monotonicity may be monomodality. In this case, if the state or action used in the unit learning step is interposed between two states or actions of the control target having the experience level greater than the state or action used in the unit learning step, the updating unit 304 determines that the value function is to be updated. For example, the updating unit 304 determines whether to update the value function as in the fifth operation example described later with reference to FIGS. 14 to 16.

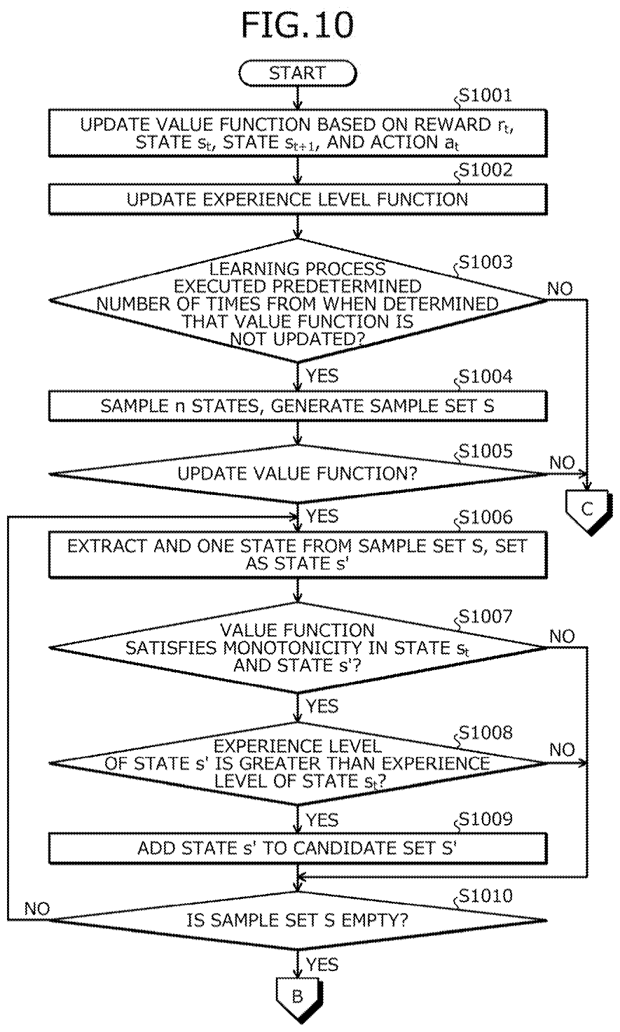

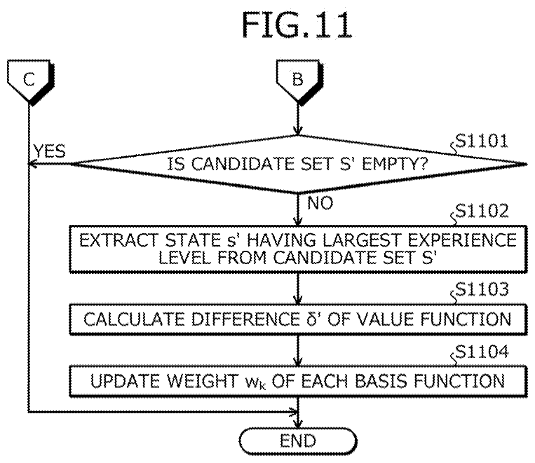

After determining that the value function is not to be updated, the updating unit 304 needs not determine whether to update the value function until the unit learning step is executed a predetermined number of times. After the unit learning step is executed a predetermined number of times, the updating unit 304 determines whether to update the value function. For example, the updating unit 304 determines whether to update the value function as in the third operation example described later with reference to FIGS. 10 and 11. As a result, after once determining not to make the update, the updating unit 304 may determine based on several executions of the unit learning step that update is relatively unlikely to be required and may omit the processes of determination and update, thereby enabling the processing amount to be reduced.

When determining that the value function is to be updated, the updating unit 304 updates the value function. For example, the updating unit 304 updates the value function, based on the monotonicity. For example, the updating unit 304 updates the value function such that the value of the state or action used in the unit learning step approaches the value of the state or action of the control target having an experience level greater than the state or action used in the unit learning step. For example, the updating unit 304 updates the value function as in the first to third operation examples described later with reference to FIGS. 6 to 11.

For example, the updating unit 304 may update the value function such that the value of the state or action of the control target having an experience level smaller than the state or action used in the unit learning step approaches the value of the state or action used in the unit learning step. For example, the updating unit 304 updates the value function as in the fourth operation example described later with reference to FIGS. 12 and 13.

For example, if the monotonicity is monomodality, the updating unit 304 updates the value function such that the value of the state or action used in the unit learning step approaches a value of any state or action of the control target having an experience level greater than the state or action used in the unit learning step. For example, the updating unit 304 updates the value function as in the fifth operation example described later with reference to FIGS. 14 to 16.

The updating unit 304 may further update the control law, based on the updated value function. The updating unit 304 updates the control law, based on the updated value function according to Q learning, SARSA, or actor-critic, for example. As a result, the updating unit 304 may update the control law, thereby enabling the control target to be controlled more efficiently.

Although the learning unit 302 reflects the learning result of the unit learning step to the value function before the updating unit 304 determines whether to further update the value function and updates the value function in this description, the present invention is not limited hereto. For example, the learning unit 302 may pass the learning result of the unit learning step to the updating unit 304 without reflecting the learning result to the value function, and the updating unit 304 may further update the value function while reflecting the learning result of the unit learning step to the value function in some cases.

In this case, the updating unit 304 determines whether to update the value function, based on the value function after the previous unit learning step and the calculated contribution level before the learning unit 302 reflects the learning result of the current unit learning step to the value function.

When determining that the value function is to be updated, the updating function 304 reflects the learning result of the current unit learning step to the value function and updates the value function. When determining that the value function is not to be updated, the updating unit 304 reflects the learning result of the current unit learning step to the value function. As a result, the updating unit 304 may facilitate the acquisition of the accurate value function.

The output unit 305 determines the action to the control target according to the control rule and performs the action. For example, the action is a command value for the control target. For example, the output unit 305 outputs a command value for the control target to the control target. As a result, the output unit 305 may control the control target.

The output unit 305 may output a process result of any of the functional units. A format of the output is, for example, display on a display, print output to a printer, transmission to an external apparatus via the network I/F 203, or storage in the storage areas of the memory 202, the recording medium 205, etc. As a result, the output unit 305 may improve the convenience of the reinforcement learning apparatus 100.

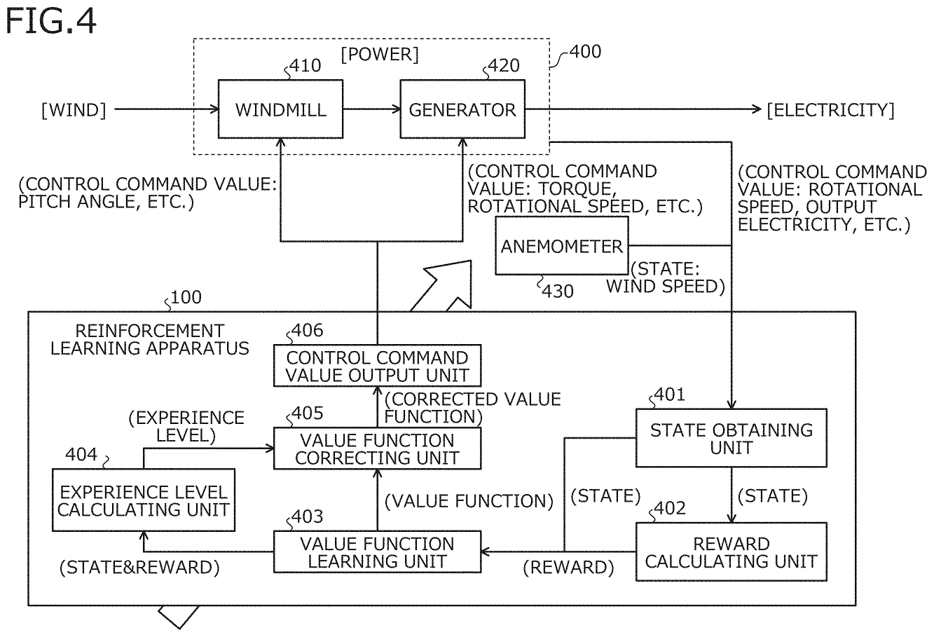

With reference to FIG. 4, description will be made of a specific example of the functional configuration of the reinforcement learning apparatus 100 when the control target of the reinforcement learning is a wind power generation facility.

FIG. 4 is a block diagram depicting a specific example of the functional configuration of the reinforcement learning apparatus 100. A wind power generation facility 400 includes a windmill 410 and a generator 420. When wind blows against the windmill 410, the windmill 410 operates based on a control command value of the reinforcement learning apparatus 100 to convert the wind into a power and send the power to the generator 420. The generator 420 operates based on the control command value of the reinforcement learning apparatus 100 to generate electricity by using the power of the windmill 410. Further, for example, an anemometer 430 is installed for the wind power generation facility 400. For example, the anemometer 430 is installed near the wind power generation facility 400. The anemometer 430 measures wind speed with respect to the wind power generation facility 400.

The reinforcement learning apparatus 100 includes a state obtaining unit 401, a reward calculating unit 402, a value function learning unit 403, an experience level calculating unit 404, a value function correcting unit 405, and a control command value output unit 406. The state obtaining unit 401 obtains the rotational speed, output electricity, the wind speed measured by the anemometer 430, etc. of the generator 420 as a state of the wind power generation facility 400. The state obtaining unit 401 outputs the state of the wind power generation facility 400 to the reward calculating unit 402 and the value function learning unit 403.

The reward calculating unit 402 calculates the reward of the wind power generation facility 400 based on the state of the wind power generation facility 400 and the action on the wind power generation facility 400. For example, the reward is a power generation amount per unit time, etc. The action on the wind power generation facility 400 is the control command value and may be received from the control command value output unit 406. The reward calculating unit 402 outputs the reward of the wind power generation facility 400 to the value function learning unit 403.

The value function learning unit 403 executes the unit learning step and learns the value function based on the received state of the wind power generation facility 400 and reward of the wind power generation facility 400 as well as the action on the wind power generation facility 400. The value function learning unit 403 outputs the learned value function to the value function correcting unit 405. The value function learning unit 403 transfers the received state of the wind power generation facility 400 and reward of the wind power generation facility 400 to the experience level calculating unit 404.

The experience level calculating unit 404 updates the experience level function based on the received state of the wind power generation facility 400 and reward of the wind power generation facility 400 as well as the action on the wind power generation facility 400. The experience level calculating unit 404 calculates the experience level of the current state or action of the wind power generation facility 400 and the experience level of another state or action based on the experience level function. The experience level calculating unit 404 outputs the calculated experience levels to the value function correcting unit 405.

The value function correcting unit 405 determines whether to further update the value function based on the value function and the experience level. When determining that the value function is to be updated, the value function correcting unit 405 updates the value function based on the value function and the experience level by using the monotonicity. When the value function is to be updated, the function value correction unit 405 outputs the updated value function to the control command value output unit 406. When the value function is not to be updated, the value function correcting unit 405 transfers the value function to the control command value output unit 406 without updating the value function.

The control command value output unit 406 updates the control law based on the value function, decides the control command value that is to be output to the wind power generation facility 400 based on the control law, and outputs the decided control command value. For example, the control command value is a command value for a pitch angle of the windmill 410. For example, the control command value is a command value for a torque or rotational speed of the generator 420. The reinforcement learning apparatus 100 may control the wind power generation facility 400 in this way.

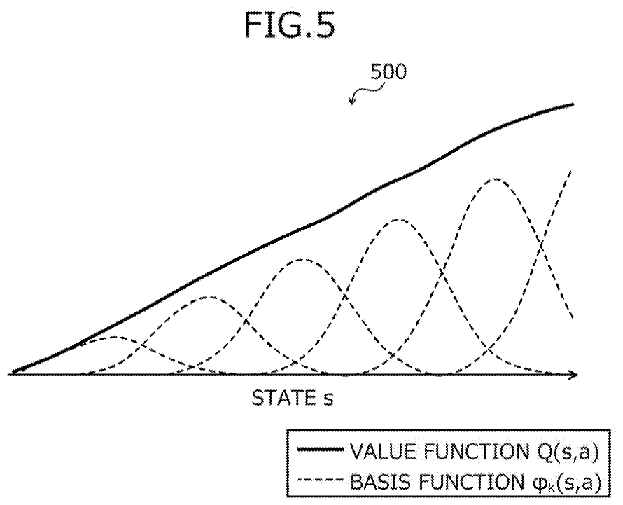

The first to fifth operation examples of the reinforcement learning apparatus 100 will be described. A definition example of the value function and common to the first to fifth operation examples of the reinforcement learning apparatus 100 will first be described with reference to FIG. 5.

FIG. 5 is an explanatory diagram depicting the definition example of the value function. In a graph 500 depicted in FIG. 5, a value function Q(s,a) is indicated by a solid line. In the graph 500 depicted in FIG. 5, a basis function φₖ(s,a) representative of the value function Q(s,a) is indicated by a broken line. For example, the value function Q(s,a) is defined by equation (1) using the basis function φₖ(s,a), where wₖ is the weight of the basis function φₖ(s,a), s is an arbitrary state, a is any action, and b is a constant.

$$Q ( s , a ) = {\sum }_{k} {w}_{k} {φ}_{k} ( s , a ) + b \qquad ( 1 )$$

The first operation example of the reinforcement learning apparatus 100 in the case of the value function Q(s,a) defined by equation (1) will be described with reference to FIG. 6.

FIG. 6 is an explanatory diagram depicting the first operation example of the reinforcement learning apparatus 100. In the description of the example of FIG. 6, the reinforcement learning apparatus 100 learns the value function at any point in time and updates the experience level function based on the contribution level of the state of the control target to the reinforcement learning. A graph 610 represents the value function learned at any point in time. A graph 620 represents the experience level function updated at any point in time. In the graphs 610, 620, “×” indicates a state at any point in time.

In this case, the reinforcement learning apparatus 100 searches for another state not satisfying the monotonicity of the value function with respect to the state at any point in time and having the experience level greater than the state at any point in time. This monotonicity is a property of monotonic increase. For example, the reinforcement learning apparatus 100 searches for a state having a small value and a large experience level from states larger than the state at any point in time and a state having a large value and a large experience level from states smaller than the state at any point in time.

In the example in FIG. 6, the states not satisfying the monotonicity of the value function with respect to the state at any point in time are included in ranges 611, 612. The states having the experience level greater than the state at any point in time are included in ranges 621, 622. Therefore, the reinforcement learning apparatus 100 searches for another state from ranges 631, 632.

The reinforcement learning apparatus 100 updates the value function by correcting the value corresponding to “×” in the value function based on the value of the one or more found states. For example, the reinforcement learning apparatus 100 updates the value function by correcting the value corresponding to “x” in the value function based on the value of the state having the largest experience level of the one or more found states.

Description will further be made of a series of operations of the reinforcement learning apparatus 100 learning the value function, updating the experience level function based on the contribution level of the state, determining whether to update the value function, and making the update when determining that the value function is to be updated.

For example, first, the reinforcement learning apparatus 100 calculates a TD error δ by equation (2), where t is a time indicated by a multiple of a unit time, t+1 is the next time after the unit time has elapsed from time t, sₜ is the state at time t, sₜ₊₁ is a state at the next time t+1, aₜ is the action at time t, Q(s,a) is the value function, and γ is a discount rate. A value of γ is from 0 to 1.

δ=rₜ+γmaxₐQ(sₜ₊₁, aₜ)−Q(sₜ, aₜ) (2)

The reinforcement learning apparatus 100 then updates the weight wₖ applied to each basis function φk(s,a) by equation (3) based on the calculated TD error.

wₖ←wₖ+αδϕₖ(sₜ, aₜ) (3)

The reinforcement learning apparatus 100 updates the experience level function E(s,a) by equations (4) and (5) based on the contribution level |φₖ(sₜ,aₜ)|. The weight applied to the experience level function E(s,a) is denoted by eₖ.

$$\begin{matrix}E ( s , a ) = {\sum }_{k} {e}_{k} {φ}_{k} ( s , a ) & ( 4 ) \\ {e}_{k} ← {e}_{k} + \vert {φ}_{k} ( {s}_{t} , {a}_{t} ) \vert & ( 5 )\end{matrix}$$

The reinforcement learning apparatus 100 searches for a state not satisfying the monotonicity of the value function with respect to the state sₜ and having the experience level greater than the state sₜ. For example, the reinforcement learning apparatus 100 samples multiple states from the vicinity of the state sₜ and generates a sample set S. The reinforcement learning apparatus 100 then searches for a state s′ satisfying equations (6) and (7) from the sample set S.

sₜ<s′∧Q(sₜ, aₜ)>Q(s′, aₜ))∨(sₜ>s′∧Q(sₜ, aₜ)<Q(s′, aₜ)) (6)

E(sₜ, aₜ)<E(s′, aₜ) (7)

If no state is found, the reinforcement learning apparatus 100 determines not to update the value function. On the other hand, if one or more states are found, the reinforcement learning apparatus 100 determines that the value function is to be updated. When determining that the value function is to be updated, the reinforcement learning apparatus 100 selects from the one or more found states, any state s′ by equation (8).

s′=argmax_{s∈S}E(s, aₜ) (8)

The reinforcement learning apparatus 100 then calculates a difference δ′ between the value of the state sₜ and the value of the selected state s′ by equation (9) based on the value of the selected state s′.

δ′Q(s′,aₜ)−Q(sₜ, aₜ) (9)

The reinforcement learning apparatus 100 then updates the weight wₖ applied to each basis function φk(s,a) by equation (10), based on the calculated difference δ′.

wₖ←wₖ+αδ′^{ϕ}^{ₖ}^{(s}^{ₜ}^{,a}^{ₜ}⁾ (10)

As a result, the reinforcement learning apparatus 100 may update the value function so that the value of the current state sₜ approaches the value of the other state s′ having the experience level greater than the current state sₜ. The reinforcement learning apparatus 100 uses the value of the other state s′ having the experience level greater than the current state sₜ and therefore, may reduce the error of the value function and improve the accuracy of the value function. Additionally, the reinforcement learning apparatus 100 may suppress a correction width at the time of updating of the value function to be equal to or less than the difference δ′ between the value of the current state sₜ and the value of the other state s′ and may reduce the possibility of adversely affecting the accuracy of the value function.

The reinforcement learning apparatus 100 may update the value function by the same technique as the learning of the value function. For example, the reinforcement learning apparatus 100 may update the value function by equations (9) and (10) similar to equation (2) and (3) related to the learning of the value function. In other words, the reinforcement learning apparatus 100 may integrate the learning and the updating of the value function into equation (11). Therefore, the reinforcement learning apparatus 100 may reduce the possibility of adversely affecting a framework of reinforcement learning in which a value function is represented by a basis function.

wₖ←wₖ+α(δ+δ′)ϕₖ(sₜ, aₜ) (11)

In this way, the reinforcement learning apparatus 100 may reduce the processing time required for the reinforcement learning and may improve the learning efficiency through reinforcement learning. How the learning efficiency through reinforcement learning is improved will be described later with reference to FIGS. 17 to 22, for example.

Although the reinforcement learning apparatus 100 updates the experience level degree function when learning the value function in this description, the present invention is not limited hereto. For example, the reinforcement learning apparatus 100 may update the experience level function both when learning the value function and when updating the value function in some cases. An operation example corresponding to this case is the second operation example described later.

Although the reinforcement learning apparatus 100 determines whether to update the value function each time the value function is learned in this description, the present invention is not limited hereto. For example, when after it is determined once that the value function is not to be updated, it is then determined that updating of the value function is relatively unlikely to be required even if the value function is learned several times. Therefore, after determining once not to make the update, the reinforcement learning apparatus 100 may omit the processes of determination and update in some cases. In this case, the reinforcement learning apparatus 100 may determine not to update the value function based on a difference between the maximum value and the minimum value of the experience level. An operation example corresponding to this case is the third operation example described later.

Although the reinforcement learning apparatus 100 updates the value function so that the value of the current state sₜ approaches the value of the other state s′ having the experience level greater than the current state sₜ in this description, the present invention is not limited hereto. For example, the reinforcement learning apparatus 100 may update the value function so that the value of the other state s′ having the experience level smaller than the current state sₜ approaches the value of the current state sₜ in some cases. An operation example corresponding to this case is the fourth operation example described later.

Although the monotonicity is monotonic increase in this description, the present invention is not limited hereto. For example, the monotonicity may be monomodality in some cases. An operation example in this case is the fifth operation example described later.

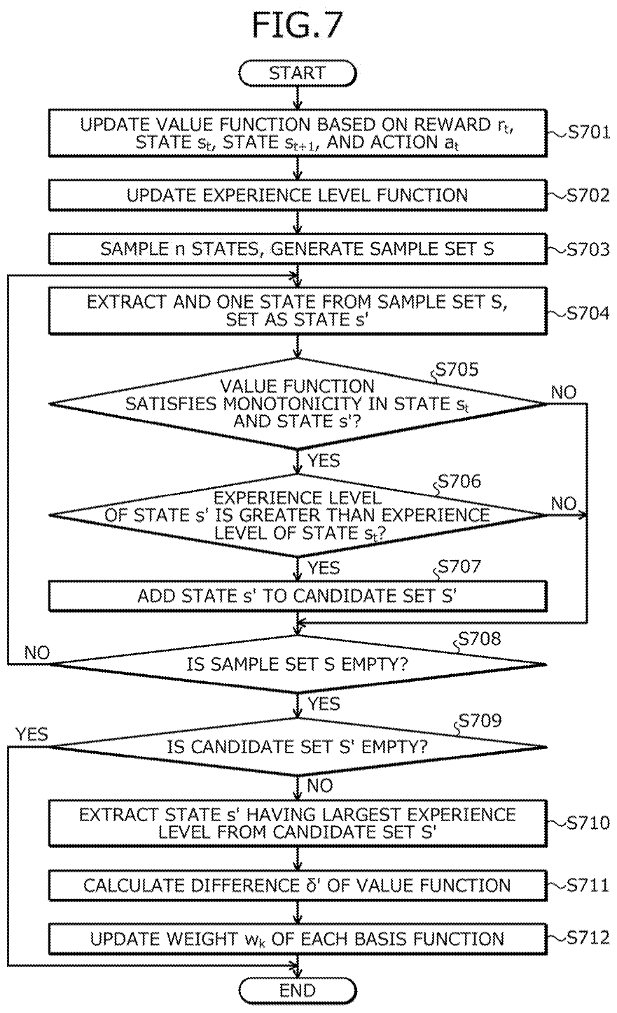

An example of a learning process procedure performed by the reinforcement learning apparatus 100 will be described with reference to FIG. 7. The learning process is implemented by the CPU 201, the storage areas of the memory 202, the recording medium 205 etc., and the network I/F 203 depicted in FIG. 2, for example.

FIG. 7 is a flowchart depicting an example of the learning process procedure in the first operation example. In FIG. 7, the reinforcement learning apparatus 100 updates the value function by equations (2) and (3), based on the reward rₜ, the state sₜ, the state sₜ₊₁, and the action aₜ (step S701). The reinforcement learning apparatus 100 then updates the experience level function by equations (4) and (5) (step S702).

The reinforcement learning apparatus 100 then samples n states to generate the sample set S (step S703). The reinforcement learning apparatus 100 extracts and sets one state from the sample set S as the state s′ (step S704). The reinforcement learning apparatus 100 then judges whether the value function satisfies the monotonicity in the state sₜ and the state s′ by equation (6) (step S705).

If the monotonicity is not satisfied (step S705: NO), the reinforcement learning apparatus 100 goes to the process at step S708. On the other hand, if the monotonicity is satisfied (step S705: YES), the reinforcement learning apparatus 100 goes to the process at step S706.

At step S706, the reinforcement learning apparatus 100 judges whether the experience level of the state s′ is greater than the experience level of the state sₜ by equation (7) (step S706). If the experience level of the state s′ is equal to or less than the experience level of the state sₜ (step S706: NO), the reinforcement learning apparatus 100 goes to the process at step S708. On the other hand, if the experience level of the state s′ is greater than the experience level of the state sₜ (step S706: YES), the apparatus goes to the process at step S707.

At step S707, the reinforcement learning apparatus 100 adds the state s′ to a candidate set S′ (step S707). The reinforcement learning apparatus 100 then goes to the process at step S708.

At step S708, the reinforcement learning apparatus 100 judges whether the sample set S is empty (step S708). If the sample set S is not empty (step S708: NO), the reinforcement learning apparatus 100 returns to the process at step S704. On the other hand, if the sample set S is empty (step S708: YES), the reinforcement learning apparatus 100 goes to the process at step S709.

At step S709, the reinforcement learning apparatus 100 determines whether the candidate set S′ is empty (step S709). If the candidate set S′ is empty (step S709: YES), the reinforcement learning apparatus 100 terminates the learning process. On the other hand, if the candidate set S′ is not empty (step S709: NO), the reinforcement learning apparatus 100 goes to the process at step S710.

At step S710, the reinforcement learning apparatus 100 extracts the state s′ having the largest experience level from the candidate set S′ by equation (8) (step S710). The reinforcement learning apparatus 100 then calculates the difference δ′ of the value function by equation (9) (step S711).

The reinforcement learning apparatus 100 then updates the weight wₖ of each basis function with wₖ←wₖ+αδ′φₖ(sₜ, aₜ) by equation (10) (step S712). Subsequently, the reinforcement learning apparatus 100 terminates the learning process. As a result, the reinforcement learning apparatus 100 may reduce the processing time required for the reinforcement learning and may improve the learning efficiency through reinforcement learning.

The second operation example of the reinforcement learning apparatus 100 in the case of the value function Q(s,a) defined by equation (1) will be described. Updating the value function may be considered as giving the same effect as learning the value function, and updating the value function may also be considered as increasing the experience level. Therefore, the reinforcement learning apparatus 100 updates the experience level function both when the value function is learned and when the value function is updated.

As with the first operation example, the reinforcement learning apparatus 100 calculates the TD error b by equation (2) and updates the weight wₖ applied to each basis function φₖ(s,a) by equation (3) based on the calculated TD error. As with the first operation example, the reinforcement learning apparatus 100 then updates the experience level function E(s,a) by equations (4) and (5).

As with the first operation example, the reinforcement learning apparatus 100 searches for a state not satisfying the monotonicity of the value function with respect to the state sₜ and having an experience level greater than that of the state sₜ. If no state is found, the reinforcement learning apparatus 100 determines not to update the value function. On the other hand, if one or more states are found, the reinforcement learning apparatus 100 determines that the value function is to be updated. As with the first operation example, when determining that the value function is to be updated, the reinforcement learning apparatus 100 selects from the one or more found states, any state s′ by equation (8).

As with the first operation example, the reinforcement learning apparatus 100 then calculates the difference δ′ between the value of the state sₜ and the value of the selected state s′ by equation (9), based on the value of the selected state s′. As with the first operation example, the reinforcement learning apparatus 100 then updates the weight wₖ applied to each basis function φk(s,a) by equation (10), based on the calculated difference δ′. Unlike the first operation example, the reinforcement learning apparatus 100 further updates the experience level function E(s,a) by equation (12), where ε is a predetermined value.

eₖ←eₖ+ε|ϕₖ(sₜ, aₜ)| (12)

As a result, the reinforcement learning apparatus 100 may reduce the processing time required for the reinforcement learning and may improve the learning efficiency through reinforcement learning. How the learning efficiency though the reinforcement learning is improved will be described later with reference to FIGS. 17 to 22, for example. Additionally, the reinforcement learning apparatus 100 may improve the accuracy of the experience level function.

An example of a learning process procedure performed by the reinforcement learning apparatus 100 will be described with reference to FIGS. 8 and 9. The learning process is implemented by the CPU 201, the storage areas of the memory 202, the recording medium 205 etc., and the network I/F 203 depicted in FIG. 2, for example.

FIGS. 8 and 9 are flowcharts depicting an example of the learning process procedure in the second operation example. In FIG. 8, the reinforcement learning apparatus 100 updates the value function by equations (2) and (3), based on the reward rₜ, the state sₜ, the state sₜ₊₁, and the action aₜ (step S801). The reinforcement learning apparatus 100 then updates the experience level function by equations (4) and (5) (step S802).

The reinforcement learning apparatus 100 then samples n states to generate the sample set S (step S803). The reinforcement learning apparatus 100 extracts and sets one state from the sample set S as the state s′ (step S804). The reinforcement learning apparatus 100 then judges whether the value function satisfies the monotonicity in the state sₜ and the state s′ by equation (6) (step S805).

If the monotonicity is not satisfied (step S805: NO), the reinforcement learning apparatus 100 goes to the process at step S808. On the other hand, if the monotonicity is satisfied (step S805: YES), the reinforcement learning apparatus 100 goes to the process at step S806.

At step S806, the reinforcement learning apparatus 100 judges whether the experience level of the state s′ is greater than the experience level of the state sₜ by equation (7) (step S806). If the experience level of the state s′ is equal to or less than the experience level of the state sₜ (step S806: NO), the reinforcement learning apparatus 100 goes to the process at step S808. On the other hand, if the experience level of the state s′ is greater than the experience level of the state sₜ (step S806: YES), the apparatus goes to the process at step S807.

At step S807, the reinforcement learning apparatus 100 adds the state s′ to a candidate set S′ (step S807). The reinforcement learning apparatus 100 then goes to the process at step S808.

At step S808, the reinforcement learning apparatus 100 judges whether the sample set S is empty (step S808). If the sample set S is not empty (step S808: NO), the reinforcement learning apparatus 100 returns to the process at step S804. On the other hand, if the sample set S is empty (step S808: YES), the reinforcement learning apparatus 100 goes to the process at step S901. Here, description continues with reference to FIG. 9.

In FIG. 9, the reinforcement learning apparatus 100 determines whether the candidate set S′ is empty (step S901). If the candidate set S′ is empty (step S901: YES), the reinforcement learning apparatus 100 terminates the learning process. On the other hand, if the candidate set S′ is not empty (step S901: NO), the reinforcement learning apparatus 100 goes to the process at step S902.

At step S902, the reinforcement learning apparatus 100 extracts the state s′ having the largest experience level from the candidate set S′ by equation (8) (step S902). The reinforcement learning apparatus 100 then calculates the difference δ′ of the value function by equation (9) (step S903).

The reinforcement learning apparatus 100 then updates the weight wₖ of each basis function by equation (10) (step S904). Subsequently, the reinforcement learning apparatus 100 updates the experience level function by equation (12) (step S905). Subsequently, the reinforcement learning apparatus 100 terminates the learning process. As a result, the reinforcement learning apparatus 100 may reduce the processing time required for the reinforcement learning and may improve the learning efficiency through reinforcement learning.

The third operation example of the reinforcement learning apparatus 100 in the case of the value function Q(s,a) defined by equation (1) will be described. When it is determined once that the value function is not to be updated, it is then determined that updating of the value function is relatively unlikely to be required even if the value function is learned several times. Additionally, when a difference between the maximum value and the minimum value of the experience level is relatively small, it is determined that the possibility of adversely affecting the learning efficiency is relatively low even if the value function is not updated. Therefore, the reinforcement learning apparatus 100 omits the processes of determination and update in a certain situation.

As with the first operation example, the reinforcement learning apparatus 100 calculates the TD error δ by equation (2) and based on the calculated TD error, updates the weight wₖ applied to each basis function φₖ(s,a) by equation (3). As with the first operation example, the reinforcement learning apparatus 100 then updates the experience level function E(s,a) by equations (4) and (5).

As with the first operation example, the reinforcement learning apparatus 100 searches for a state not satisfying the monotonicity of the value function with respect to the state sₜ and having an experience level greater than that of the state sₜ. Here, unlike the first operation example, the reinforcement learning apparatus 100 determines by equations (13) and (14), whether the value function needs to be updated.

$$\begin{matrix}∀ s , {s}^{′} ∈ S , ( {s}_{t} < {s}^{′} Q ( s , a ) > Q ( {s}^{′} , a ) ) ( s > {s}^{′} Q ( s , a ) < Q ( {s}^{′} , a ) ) & ( 13 ) \\ {max}_{s ∈ S} E ( s , a ) - {min}_{s ∈ S} E ( s , a ) < ɛ & ( 14 )\end{matrix}$$

If equations (13) and (14) are satisfied, the reinforcement learning apparatus 100 determines that the value function does not need to be updated. Subsequently, the reinforcement learning apparatus 100 omits the processes of determination and update until the learning of the value function is repeated a predetermined number of times. After the learning of the value function is repeated a predetermined number of times, the reinforcement learning apparatus 100 determines by equation (13) and equation (14) again whether the value function needs to be updated.

On the other hand, If equations (13) and (14) are not satisfied, the reinforcement learning apparatus 100 determines that the value function needs to be updated. As with the first operation example, when determining that the value function is to be updated, the reinforcement learning apparatus 100 selects from the one or more found states, any state s′ by equation (8).

As with the first operation example, the reinforcement learning apparatus 100 then calculates the difference δ′ between the value of the state sₜ and the value of the selected state s′ by equation (9), based on the value of the selected state s′. As with the first operation example, the reinforcement learning apparatus 100 then updates the weight wₖ applied to each basis function φk(s,a) by equation (10), based on the calculated difference δ′.

As a result, the reinforcement learning apparatus 100 may reduce the processing time required for the reinforcement learning and may improve the learning efficiency through reinforcement learning. How the improvement is made will be described later with reference to FIGS. 17 to 22, for example. Additionally, the reinforcement learning apparatus 100 may reduce a processing amount.

The reinforcement learning apparatus 100 may use a “period during which an accumulated learning amount of the value function and an accumulated update amount of the experience level function do not exceed a predetermined value” instead of the “predetermined number of times”. The accumulated learning amount of the value function and the accumulated update amount of the experience level function are represented by equation (15) and (16), for example.

$$\begin{matrix}{\sum }_{t = {t}_{1}}^{{t}_{2}} αδ {max}_{k} \vert {φ}_{k} ( {s}_{t} , {a}_{t} ) \vert < {ɛ}_{1} & ( 15 ) \\ {\sum }_{t = {t}_{1}}^{{t}_{2}} {max}_{k} \vert {φ}_{k} ( {s}_{t} , {a}_{t} ) \vert < {ɛ}_{2} & ( 16 )\end{matrix}$$

An example of a learning process procedure performed by the reinforcement learning apparatus 100 will be described with reference to FIGS. 10 and 11. The learning process is implemented by the CPU 201, the storage areas of the memory 202, the recording medium 205 etc., and the network I/F 203 depicted in FIG. 2, for example.

FIGS. 10 and 11 are flowcharts depicting an example of the learning process procedure in the third operation example. In FIG. 10, the reinforcement learning apparatus 100 updates the value function by equations (2) and (3), based on the reward rₜ, the state sₜ, the state sₜ₊₁, and the action aₜ (step S1001). The reinforcement learning apparatus 100 then updates the experience level function by equations (4) and (5) (step S1002).

The reinforcement learning apparatus 100 then determines whether the learning process has been executed a predetermined number of times from when it is determined that the value function is not to be updated (step S1003). If the learning process has not been executed the predetermined number of times (step S1003: NO), the reinforcement learning apparatus 100 terminates the learning process. On the other hand, if the learning process has been executed the predetermined number of times (step S1003: YES), the reinforcement learning apparatus 100 goes to the process at step S1004.

At step S1004, the reinforcement learning apparatus 100 then samples n states to generate the sample set S (step S1004). Next, the reinforcement learning apparatus 100 judges, by equations (15) and (16), whether the value function is to be updated (step S1005). Here, if the value function is not to be updated (step S1005: NO), the reinforcement learning apparatus 100 terminates the learning process. On the other hand, if the value function is to be updated (step S1005: YES), the reinforcement learning apparatus 100 goes to the process at step S1006.

At step S1006, the reinforcement learning apparatus 100 extracts and sets one state from the sample set S as the state s′ (step S1006). The reinforcement learning apparatus 100 then judges whether the value function satisfies the monotonicity in the state sₜ and the state s′ by equation (6) (step S1007). If the monotonicity is not satisfied (step S1007: NO), the reinforcement learning apparatus 100 goes to the process at step S1010. On the other hand, if the monotonicity is satisfied (step S1007: YES), the reinforcement learning apparatus 100 goes to the process at step S1008.

At step S1008, the reinforcement learning apparatus 100 judges by equation (7), whether the experience level of the state s′ is greater than the experience level of the state sₜ (step S1008). If the experience level of the state s′ is equal to or less than the experience level of the state sₜ (step S1008: NO), the reinforcement learning apparatus 100 goes to the process at step S1010. On the other hand, if the experience level of the state s′ is greater than the experience level of the state sₜ (step S1008: YES), the apparatus goes to the process at step S1009.

At step S1009, the reinforcement learning apparatus 100 adds the state s′ to the candidate set S′ (step S1009). The reinforcement learning apparatus 100 then goes to the process at step S1010.

At step S1010, the reinforcement learning apparatus 100 judges whether the sample set S is empty (step S1010). If the sample set S is not empty (step S1010: NO), the reinforcement learning apparatus 100 returns to the process at step S1006. On the other hand, if the sample set S is empty (step S1010: YES), the reinforcement learning apparatus 100 goes to the process at step S1101. Here, description continues with reference to FIG. 11.

In FIG. 11, the reinforcement learning apparatus 100 determines whether the candidate set S′ is empty (step S1101). If the candidate set S′ is empty (step S1101: YES), the reinforcement learning apparatus 100 terminates the learning process. On the other hand, if the candidate set S′ is not empty (step S1101: NO), the reinforcement learning apparatus 100 goes to the process at step S1102.

At step S1102, the reinforcement learning apparatus 100 extracts the state s′ having the largest experience level from the candidate set S′ by equation (8) (step S1102). The reinforcement learning apparatus 100 then calculates the difference δ′ of the value function by equation (9) (step S1103).

The reinforcement learning apparatus 100 then updates the weight wₖ of each basis function by equation (10) (step S1104). Subsequently, the reinforcement learning apparatus 100 terminates the learning process. As a result, the reinforcement learning apparatus 100 may reduce the processing time required for the reinforcement learning and may improve the learning efficiency through reinforcement learning. Further, the reinforcement learning apparatus 100 may facilitate reduction of the processing amount.

The fourth operation example of the reinforcement learning apparatus 100 in the case of the value function Q(s,a) defined by equation (1) will be described. The value learning function 100 can improve the accuracy of the value function even by updating the value function so that the value of the other state s′ having the experience level smaller than the current state sₜ approaches the value of the current state sₜ.

As with the first operation example, the reinforcement learning apparatus 100 calculates the TD error δ by equation (2) and based on the calculated TD error, updates the weight wₖ applied to each basis function φₖ(s,a) by equation (3). Unlike the first operation example, the reinforcement learning apparatus 100 searches for a state not satisfying the monotonicity of the value function with respect to the state sₜ and satisfying equation (17), i.e., having a large difference in the experience level from the state sₜ.

|E(sₜ, aₜ)−E(s′, aₜ)|>ε (17)

If no state is found, the reinforcement learning apparatus 100 determines not to update the value function. On the other hand, if one or more states are found, the reinforcement learning apparatus 100 determines that the value function is to be updated. Unlike the first operation example, when determining that the value function is to be updated, the reinforcement learning apparatus 100 selects any state s′ from the one or more found states by equation (18).

s′=argmax_{s∈S}−E(s, aₜ)−E(sₜ, aₜ)| (18)

The reinforcement learning apparatus 100 sets the state sₜ and the selected state s′ to a state s₁ and a state s₂. For example, when equation (19) is satisfied, the reinforcement learning apparatus 100 sets the state sₜ and the selected state s′ to the state s₁ and the state s₂ by equation (20).

E(s′, aₜ)<E(sₜ, aₜ) (19)

s₁=sₜ, s₂=s′ (20)

For example, when equation (21) is satisfied, the reinforcement learning apparatus 100 sets the state sₜ and the selected state s′ to the state s₁ and the state s₂ by equation (22).

E(s′, aₜ)>E(sₜ, aₜ) (21)

s₁=s′, s₂=sₜ (22)

The reinforcement learning apparatus 100 then calculates the difference δ′ of the value between the state s₁ and the state s₂ by equation (23), based on the values of the state s₁ and the state s₂.

δ′=Q(s₁, aₜ)−Q(s₂, aₜ) (23)

The reinforcement learning apparatus 100 then, by equation (24), updates the weight wₖ applied to each basis function φk(s,a), based on the calculated difference δ′.

wₖ←wₖ+αδ′ϕₖ(s₂, aₜ) (24)

As a result, the reinforcement learning apparatus 100 may reduce the processing time required for the reinforcement learning and may improve the learning efficiency through reinforcement learning. The reinforcement learning apparatus 100 may further improve the learning efficiency through reinforcement learning by updating the value function in two ways. How the learning efficiency through reinforcement learning is improved will be described later with reference to FIGS. 17 to 22, for example.

An example of a learning process procedure performed by the reinforcement learning apparatus 100 will be described with reference to FIGS. 12 and 13. The learning process is implemented by the CPU 201, the storage areas of the memory 202, the recording medium 205 etc., and the network I/F 203 depicted in FIG. 2, for example.

FIGS. 12 and 13 are flowcharts depicting an example of the learning process procedure in the fourth operation example. In FIG. 12, the reinforcement learning apparatus 100 updates the value function by equations (2) and (3), based on the reward rₜ, the state sₜ, the state sₜ₋₁, and the action at (step S1201). The reinforcement learning apparatus 100 then updates the experience level function by equations (4) and (5) (step S1202).

The reinforcement learning apparatus 100 then samples n states to generate the sample set S (step S1203). Next, the reinforcement learning apparatus 100 extracts and sets one state from the sample set S as the state s′ (step S1204). The reinforcement learning apparatus 100 then judges whether the value function satisfies the monotonicity in the state sₜ and the state s′ by equation (6) (step S1205).

If the monotonicity is not satisfied (step S1205: NO), the reinforcement learning apparatus 100 goes to the process at step S1208. On the other hand, if the monotonicity is satisfied (step S1205: YES), the reinforcement learning apparatus 100 goes to the process at step S1206.

At step S1206, the reinforcement learning apparatus 100 judges by equation (17), whether the experience level difference is greater than the predetermined value c (step S1206). If the experience level difference is less than or equal to the predetermined value c (step S1206: NO), the reinforcement learning apparatus 100 goes to the process at step S1208. On the other hand, if the experience level difference is greater than the predetermined value c (step S1206: YES), the apparatus goes to the process at step S1207.

At step S1207, the reinforcement learning apparatus 100 adds the state s′ to the candidate set S′ (step S1207). The reinforcement learning apparatus 100 then goes to the process at step S1208.

At step S1208, the reinforcement learning apparatus 100 judges whether the sample set S is empty (step S1208). If the sample set S is not empty (step S1208: NO), the reinforcement learning apparatus 100 returns to the process at step S1204. On the other hand, if the sample set S is empty (step S1208: YES), the reinforcement learning apparatus 100 goes to the process at step S1301. Here, description continues with reference to FIG. 13.

In FIG. 13, the reinforcement learning apparatus 100 determines whether the candidate set S′ is empty (step S1301). If the candidate set S′ is empty (step S1301: YES), the reinforcement learning apparatus 100 terminates the learning process. On the other hand, if the candidate set S′ is not empty (step S1301: NO), the reinforcement learning apparatus 100 goes to the process at step S1302.

At step S1302, the reinforcement learning apparatus 100 extracts the state s′ having the largest experience level difference from the candidate set S′ by equation (18), and sets the larger of the state sₜ and the state s′ with respect to experience level as s₁ and the smaller thereof as s₂ (step S1302).

The reinforcement learning apparatus 100 then calculates the difference δ′ of the value function by equation (23) (step S1303). The reinforcement learning apparatus 100 then updates the weight wₖ of each basis function by equation (24) (step S1304). Subsequently, the reinforcement learning apparatus 100 terminates the learning process. As a result, the reinforcement learning apparatus 100 may reduce the processing time required for the reinforcement learning and may improve the learning efficiency through reinforcement learning.

The fifth operation example of the reinforcement learning apparatus 100 in the case of the value function Q(s,a) defined by equation (1) will be described.

FIG. 14 is an explanatory diagram depicting the fifth operation example of the reinforcement learning apparatus 100. The monotonicity is monomodality in some cases. The monomodality has a peak of the value at one position and exhibits monotonic increase in a range smaller than a peaking state and monotone decrease in a range larger than the peaking state. For example, the monomodality appears when the control target is a wind power generation facility.

In FIG. 14, for example, if other states having an experience level greater than that of the state sₜ and a value greater than that of the state sₜ are present on both sides of the state sₜ, the reinforcement learning apparatus 100 updates the value corresponding to the state sₜ in the value function, based on the values of the other states on both sides. In the example depicted in FIG. 14, the reinforcement learning apparatus 100 makes a correction if the state sₜ has a value 1401 and does not make a correction if the state sₜ has a value 1402.

For example, as with the first operation example, the reinforcement learning apparatus 100 calculates the TD error b by equation (2) and updates the weight wₖ applied to each basis function φₖ(s,a) by equation (3), based on the calculated TD error. As with the first operation example, the reinforcement learning apparatus 100 then updates the experience level function E(s,a) by equations (4) and (5). Unlike the first operation example, the reinforcement learning apparatus 100 extracts a sample set S₁ and a sample set S₂ from both sides of the state sₜ by equation (25).

S₁={s∈S: sₜ<s, Q(sₜ, aₜ)<Q(s, aₜ), E(sₜ, aₜ)<E(s, aₜ)},

S₂={s∈S: sₜ>s, Q(sₜ, aₜ)<Q(s, aₜ), E(sₜ, aₜ)<E(s, aₜ)} (25)

The reinforcement learning apparatus 100 then extracts a state s′ and a state s″ from the sample set S₁ and the sample set S₂ by equations (26) and (27).

s′=argmax_{s∈S}_{₁}E(s, aₜ) (26)

s″=argmax_{s∈S}_{₂}E(s, aₜ) (27)

The reinforcement learning apparatus 100 calculates the difference δ′ between the value of the state sₜ and the value of one of the state s′ and the state s″ closer to the value of the state sₜ by equation (28).

δ′=min{Q(s′, aₜ), Q(s″, aₜ)}−Q(sₜ, aₜ) (28)

The reinforcement learning apparatus 100 then updates the weight wₖ applied to each basis function φk(s,a) by equation (29), based on the calculated difference δ′.

wₖ←wₖ+αδ′ϕₖ(sₜ, aₜ) (29)

As a result, the reinforcement learning apparatus 100 may reduce the processing time required for the reinforcement learning and may improve the learning efficiency through reinforcement learning. How the learning efficiency through reinforcement learning is improved will be described later with reference to FIGS. 17 to 22, for example.

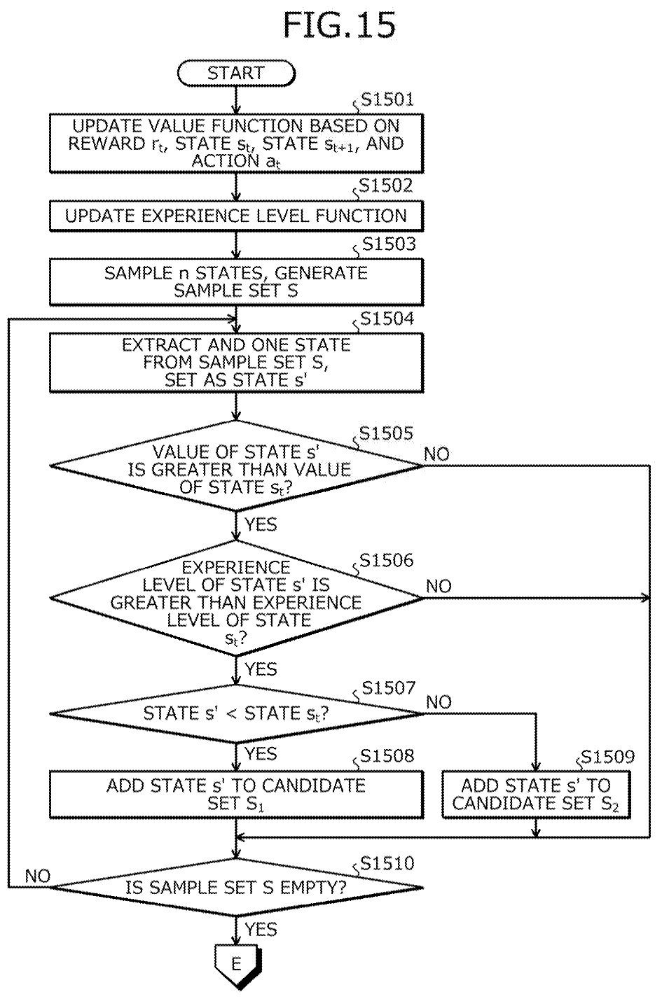

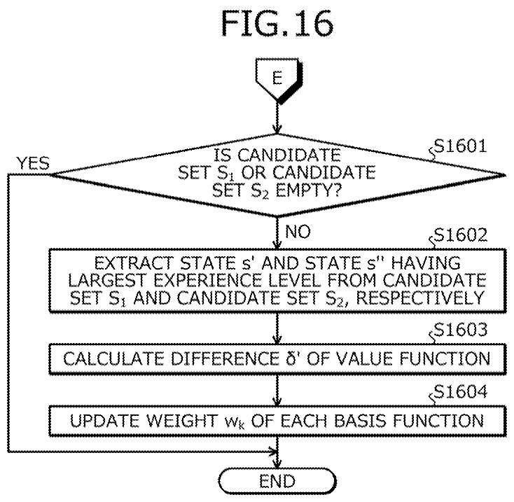

An example of a learning process procedure performed by the reinforcement learning apparatus 100 will be described with reference to FIGS. 15 and 16. The learning process is implemented by the CPU 201, the storage areas of the memory 202, the recording medium 205 etc., and the network I/F 203 depicted in FIG. 2, for example.

FIGS. 15 and 16 are flowcharts depicting an example of the learning process procedure in the fifth operation example. In FIGS. 15 and 16, the reinforcement learning apparatus 100 updates the value function by equations (2) and (3), based on the reward rₜ, the state sₜ, the state sₜ₋₁, and the action at (step S1501). The reinforcement learning apparatus 100 then updates the experience level function by equations (4) and (5) (step S1502).

The reinforcement learning apparatus 100 then samples n states to generate the sample set S (step S1503). Next, the reinforcement learning apparatus 100 extracts and sets one state from the sample set S as the state s′ (step S1504). The reinforcement learning apparatus 100 then judges whether the value of the state s′ is greater than the value of the state st by equation (30) (step S1505).

Q(sₜ, aₜ)<Q(s′, aₜ) (30)

If the value of the state s′ is equal to or less than the value of the state sₜ (step S1505: NO), the reinforcement learning apparatus 100 goes to the process at step S1510. On the other hand, if the value of the state s′ is greater than the value of the state sₜ (step S1505: YES), the reinforcement learning apparatus 100 goes to the process at step S1506.

At step S1506, the reinforcement learning apparatus 100 determines whether the experience level of the state s′ is greater than the experience level of the state st by equation (7) (step S1506). If the experience level of the state s′ is equal to or less than the experience level of the state sₜ (step S1506: NO), the reinforcement learning apparatus 100 goes to the process at step S1510. On the other hand, if the experience level of the state s′ is greater than the experience level of the state sₜ (step S1506: YES), the apparatus goes to the process at step S1507.

At step S1507, the reinforcement learning apparatus 100 determines whether the state s′<the state sₜ is satisfied (step S1507). If the state s′<the state sₜ is satisfied (step S1507: YES), the reinforcement learning apparatus 100 goes to the process at step S1508. On the other hand, if the state s′<the state sₜ is not satisfied (step S1507: NO), the reinforcement learning apparatus 100 goes to the process at step S1509.

At step S1508, the reinforcement learning apparatus 100 adds the state s′ to the candidate set S₁ (step S1508). The reinforcement learning apparatus 100 then goes to the process at step S1510.

At step S1509, the reinforcement learning apparatus 100 adds state s′ to the candidate set S₂ (step S1509). The reinforcement learning apparatus 100 then goes to the process at step S1510.

At step S1510, the reinforcement learning apparatus 100 judges whether the sample set S is empty (step S1510). If the sample set S is not empty (step S1510: NO), the reinforcement learning apparatus 100 returns to the process at step S1504. On the other hand, if the sample set S is empty (step S1510: YES), the reinforcement learning apparatus 100 goes to the process at step S1601. Here, description continues with reference to FIG. 16.

In FIG. 16, at step S1601, the reinforcement learning apparatus 100 determines whether the candidate set S₁ or the candidate set S₂ is empty (step S1601). If the candidate set S₁ or the candidate set S₂ is empty (step S1601: YES), the reinforcement learning apparatus 100 terminates the learning process. On the other hand, if the candidate set S₁ or the candidate set S₂ is not empty (step S1601: NO), the reinforcement learning apparatus 100 goes to the process at step S1602.

At step S1602, the reinforcement learning apparatus 100 extracts from the candidate set S₁ and the candidate set S₂, respectively, the state s′ and the state s″ having the largest experience level, by equations (26) and (27) (step S1602). The reinforcement learning apparatus 100 then calculates the difference δ′ of the value function by equation (28) (step S1603).

The reinforcement learning apparatus 100 then updates the weight wₖ of each basis function by equation (29) (step S1604). Subsequently, the reinforcement learning apparatus 100 terminates the learning process. As a result, the reinforcement learning apparatus 100 may reduce the processing time required for the reinforcement learning and may improve the learning efficiency through reinforcement learning even when the monotonicity is monomodality.

The learning efficiency through reinforcement learning will be described with reference to FIGS. 17 to 19. For example, in the following description, the learning efficiency through reinforcement learning in the third operation example will be compared with a case in which the value function is not updated after learning of the value function.

FIGS. 17, 18, and 19 are explanatory diagrams depicting an example of comparison of the learning efficiency through reinforcement learning. In FIGS. 17 to 19, graphs 1701 to 1703, 1801 to 1803, 1901 to 1903 represent examples of transition of the value function when the value function is not updated after learning of the value function. In FIGS. 17 to 19, graphs 1711 to 1713, 1811 to 1813, 1911 to 1913 represent examples of transition of the value function in the third operation example. The examples depicted in FIG. 17 will first be described.

In FIG. 17, the graphs 1701 to 1703 respectively represent the value function at time t₁ to t₃ in the case in which the value function is not updated. In FIG. 17, the graphs 1711 to 1713 represent the value function at time t₁ to t₃ in the third operation example. For example, comparison between the graph 1703 and the graph 1713 reveals that the reinforcement learning apparatus 100 may update the value function at time t₃ and may improve the accuracy of the value function.

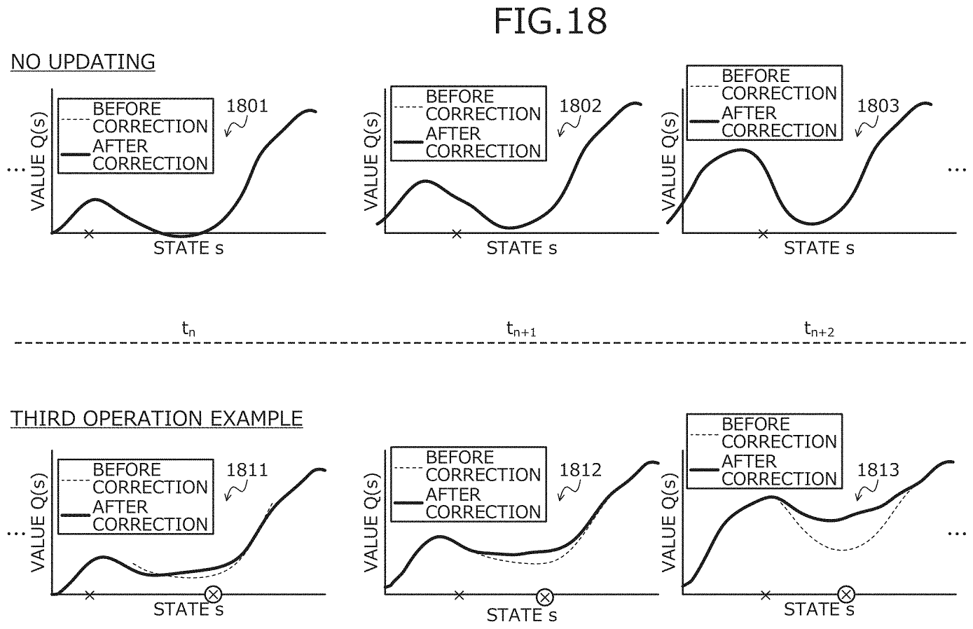

In FIG. 18, the graphs 1801 to 1803 respectively represent the value function at time tₙ to tₙ₊₂ in the case in which the value function is not to be updated. In FIG. 18, the graphs 1811 to 1813 represent the value functions at time tₙ to tₙ₊₂ in the third operation example. For example, comparison between the graph 1803 and the graph 1813 reveals that the reinforcement learning apparatus 100 may update the value function at the time tₙ₊₂ and may improve the accuracy of the value function. Referring to the graph 1803, it is revealed that when the value function is not updated, the absence of learning of the value function for some states deteriorates the accuracy of the value function.

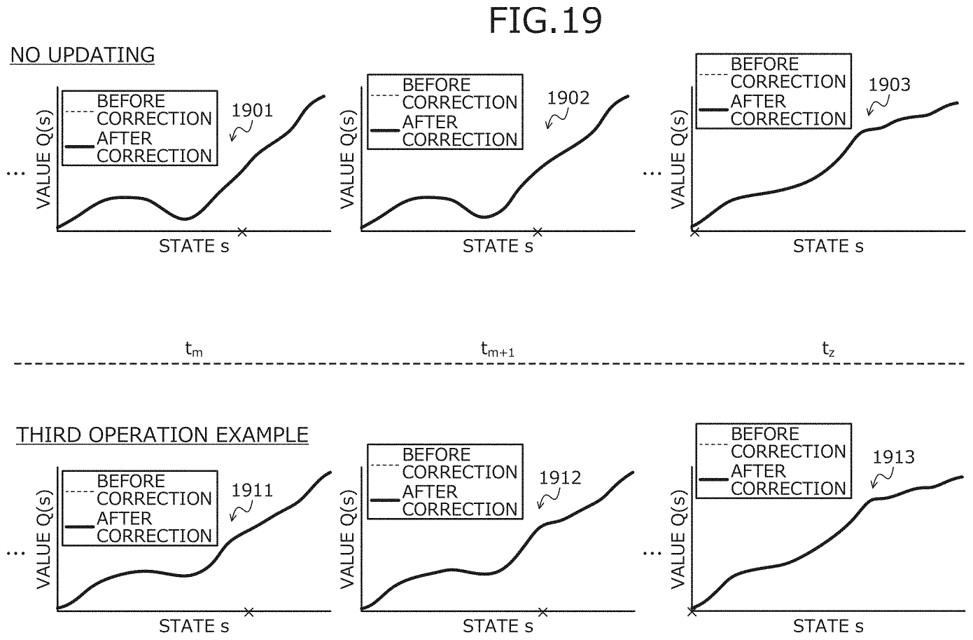

In FIG. 19, the graphs 1901 to 1903 respectively represent the value functions at time tₘ to tₘ₊₁ and time t_{z} in the case in which the value function is not updated. Time t_{z} is a time after convergence of the value function. In FIG. 19, the graphs 1911 to 1913 represent the value function at time tₘ to tₘ₊₁ and time t_{z} in the third operation example. For example, comparison between the graphs 1902, 1903 and the graphs 1912, 1913 reveals that the reinforcement learning apparatus 100 may obtain at time tₘ₊₁, the value function that is relatively close to the value function at time t_{z} and thereby, may improve the accuracy of the value function.

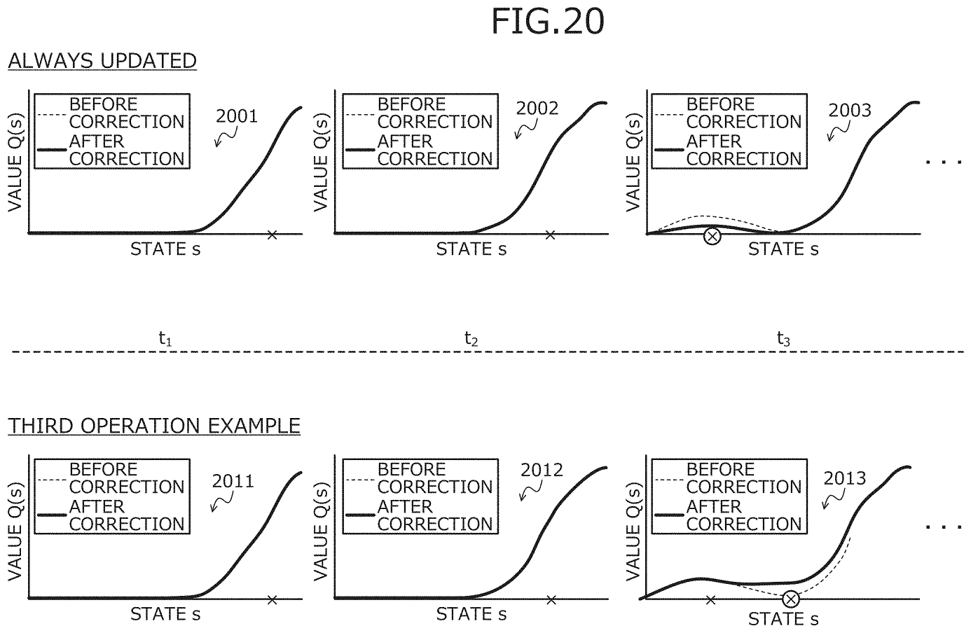

Another comparison example of the learning efficiency through reinforcement learning in the third example will be described with reference to FIGS. 20 to 22.

FIGS. 20, 21, and 22 are explanatory diagrams depicting another example of comparison of the learning efficiency through reinforcement learning. In FIGS. 20 to 22, graphs 2001 to 2003, 2101 to 2103, 2201 to 2203 represent examples of transition of the value function when the value function is always updated after learning of the value function. In FIGS. 20 to 22, graphs 2011 to 2013, 2111 to 2113, 2211 to 2213 represent examples of transition of the value function in the third operation example.

In FIG. 20, the graphs 2001 to 2003 respectively represent the value function at time t₁ to t₃ in the case in which the value function is always updated. In FIG. 20, the graphs 2011 to 2013 represent the value function at time t₁ to t₃ in the third operation example. For example, comparison between the graph 2003 and the graph 2013 reveals that the reinforcement learning apparatus 100 may update the value function at time t₃ and may improve the accuracy of the value function.

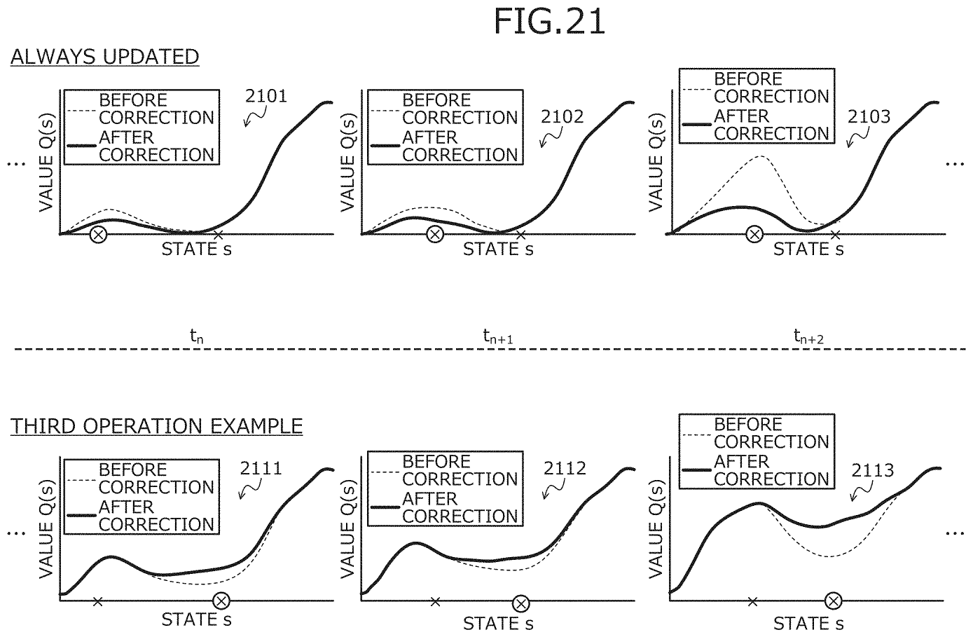

In FIG. 21, the graphs 2101 to 2103 respectively represent the value function at time tₙ to tₙ₊₂ in the case in which the value function is always updated. In FIG. 21, the graphs 2111 to 2113 represent the value functions at time tₙ to tₙ₊₂ in the third operation example. For example, comparison between the graph 2103 and the graph 2113 reveals that the reinforcement learning apparatus 100 may update the value function at the time tₙ₊₂ and may improve the accuracy of the value function. Further, comparison of the graph 2103 and graph 2113 reveals that when the value function is always updated, the value function is updated in a way that increases the error of the value function, whereby the accuracy of the value function deteriorates.

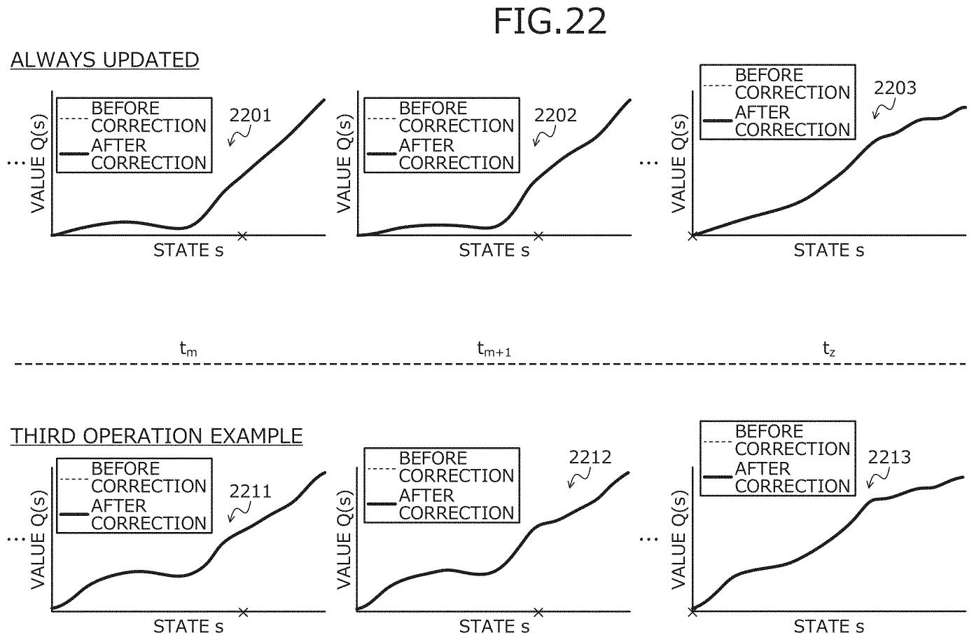

In FIG. 22, the graphs 2201 to 2203 respectively represent the value functions at time tₘ to tₘ₊₁ and time t_{z} in the case in which the value function is always updated. Time t_{z} is a time after convergence of the value function. In FIG. 22, the graphs 2211 to 2213 represent the value function at time tₘ to tₘ₊₁ and time t_{z} in the third operation example. For example, comparison between the graphs 2202, 2203 and the graphs 2212, 2213 reveals that the reinforcement learning apparatus 100 may obtain at time tₘ₊₁, the value function that is relatively close to the value function at time t_{z}and thereby, may improve the accuracy of the value function.

Although the monotonicity is established in the entire possible range of the state in this description, the present invention is not limited hereto. For example, the reinforcement learning apparatus 100 may be applied when the monotonicity is established in a portion of the possible range of the state. For example, the reinforcement learning apparatus 100 may be applied when the state of the control target is restricted and has the monotonicity within the range of the restriction.

As described above, the reinforcement learning apparatus 100 may calculate the contribution level of the state or action of the control target used in the unit learning step to the reinforcement learning by using a basis function for each unit learning step. The reinforcement learning apparatus 100 may determine whether to update the value function based on the value function after the unit learning step and the calculated contribution level. When determining that the value function is to be updated, the reinforcement learning apparatus 100 may update the value function. As a result, the reinforcement learning apparatus 100 may improve the learning efficiency through reinforcement learning.

The reinforcement learning apparatus 100 may update based on the calculated contribution level for each unit learning step, the experience level function that defines by the basis function, the experience level in the reinforcement learning for each state or action of the control target. The reinforcement learning apparatus 100 may determine whether to update the value function, based on the value function after the unit learning step and the updated experience level function. As a result, by using the experience level, the reinforcement learning apparatus 100 may facilitate the improvement in the learning efficiency through reinforcement learning.

When determining that the value function is to be updated, the reinforcement learning apparatus 100 may further update the experience level function such that the state or action of the control target used in the unit learning step is increased with respect to the experience level in the reinforcement learning. As a result, the reinforcement learning apparatus 100 may improve the accuracy of the experience level function, may improve the accuracy of using the experience level function and determining whether the value function needs to be updated, and may facilitate the acquisition of the accurate value function.

The reinforcement learning apparatus 100 may update the value function such that the value of the state or action of the control target used in the unit learning step approaches the value of the state or action of the control target having the experience level greater than the state or action of the control target used in the unit learning step. As a result, the reinforcement learning apparatus 100 may facilitate the acquisition of the accurate value function.

The reinforcement learning apparatus 100 may update the value function such that the value of the state or action of the control target having the experience level smaller than the state or action of the control target used in the unit learning step approaches the value of the state or action of the control target used in the unit learning step. As a result, the reinforcement learning apparatus 100 may facilitate the acquisition of the accurate value function.

The reinforcement learning apparatus 100 may determine that the value function is to be updated if the state or action of the control target used in the unit learning step is interposed between two states or actions of the control target having an experience level greater than that of the state or action of the control target used in the unit learning step. As a result, the reinforcement learning apparatus 100 may be applied when the characteristics of the value function have monomodality.

After determining that the value function is not to be updated, the reinforcement learning apparatus 100 may determine whether to update the value function after the unit learning step is executed a predetermined number of times. As a result, the reinforcement learning apparatus 100 may reduce the processing amount while suppressing a reduction in the learning efficiency through reinforcement learning.

The reinforcement learning apparatus 100 may determine whether to update the value function, based on the value function after the previous unit learning step and the calculated contribution level before a learning result of the current unit learning step is reflected to the value function. When determining that the value function is to be updated, the reinforcement learning apparatus 100 may reflect the learning result of the current unit learning step to the value function and update the value function. When determining that the value function is not to be updated, the reinforcement learning apparatus 100 may reflect the learning result of the current unit learning step to the value function. As a result, the reinforcement learning apparatus 100 may perform learning and updating together.

The reinforcement learning method described in the present embodiment may be implemented by executing a prepared program on a computer such as a personal computer and a workstation. A reinforcement learning program described in the embodiment is stored on a non-transitory, computer-readable recording medium such as a hard disk, a flexible disk, a CD-ROM, an MO, and a DVD, read out from the computer-readable medium, and executed by the computer. The reinforcement learning program described in the embodiment may be distributed through a network such as the Internet.

According to an aspect, learning efficiency may be improved through reinforcement learning.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A reinforcement learning method executed by a computer, the reinforcement learning method comprising:
calculating, in reinforcement learning of repeatedly executing a learning step for a value function that has monotonicity as a characteristic of a value according to a state or an action of a control target, a contribution level of the state or the action of the control target used in the learning step, the contribution level of the state or the action to the reinforcement learning being calculated for each learning step and calculated using a basis function used for representing the value function;
determining whether to update the value function, based on the value function after each learning step and the calculated contribution level calculated in each learning step; and
updating the value function when the determining determines to update the value function.

2. The reinforcement learning method according to claim 1, further comprising
updating an experience level function that defines, by the basis function, an experience level in the reinforcement learning for each state or action of the control target, based on the calculated contribution level calculated in each learning step, wherein
the determining whether to update the value function is determined based on the value function after the learning step and the updated experience level function.

3. The reinforcement learning method according to claim 2, wherein
when the value function is to be updated, the updating the experience level function includes further updating the experience level function such that the experience level of the state or the action of the control target used in the learning step is increased in the reinforcement learning.

4. The reinforcement learning method according to claim 2, wherein
the updating the value function includes updating the value function such that the value of the state or the action of the control target used in the learning step approaches a value of a second state or a second action of the control target, the second state or the second action having a second experience level that is greater than the experience level of the state or the action of the control target used in the learning step.

5. The reinforcement learning method according to claim 2, wherein
the updating the value function includes updating the value function such that a value of a second state or a second action of the control target and having a second experience level that is smaller than the experience level of the state or the action of the control target used in the learning step approaches the value of the state or the action of the control target used in the learning step.

6. The reinforcement learning method according to claim 2, wherein
the monotonicity is monomodality, and
the determining whether to update the value function includes determining to update the value function when the state or the action of the control target used in the learning step is interposed between two states or actions of the control target, the two states or actions having a second experience level that is greater than the experience level of the state or the action of the control target used in the learning step.

7. The reinforcement learning method according to claim 1, wherein
the determining whether to update the value function includes again determining whether to update the value function after the learning step is executed a predetermined number of times after the determining determines not to update the value function.

8. The reinforcement learning method according to claim 1, wherein
the determining whether to update the value function is determined based on the value function after a previous learning step and the calculated contribution level before a learning result of a current learning step is reflected to the value function, and
updating the value function includes reflecting the learning result of the current learning step to the value function and updating the value function when the determining determines to update the value function and includes reflecting the learning result of the current learning step to the value function when the determining determines not to update the value function.

9. A non-transitory, computer-readable recording medium storing therein a reinforcement learning program that causes a computer to execute a process comprising:
calculating, in reinforcement learning of repeatedly executing a learning step for a value function that has monotonicity as a characteristic of a value according to a state or an action of a control target, a contribution level of the state or the action of the control target used in the learning step, the contribution level of the state or the action to the reinforcement learning being calculated for each learning step and calculated using a basis function used for representing the value function;
determining whether to update the value function, based on the value function after each learning step and the calculated contribution level calculated in each learning step; and
updating the value function when the determining determines to update the value function.

10. A reinforcement learning apparatus comprising:
a memory; and
a processor coupled to the memory, the processor configured to:
calculate, in reinforcement learning of repeatedly executing a learning step for a value function that has monotonicity as a characteristic of a value according to a state or an action of a control target, a contribution level of the state or the action of the control target used in the learning step, the contribution level of the state or the action to the reinforcement learning being calculated for each learning step and calculated using a basis function used for representing the value function;
determine whether to update the value function, based on the value function after each learning step and the calculated contribution level calculated in each learning step; and
update the value function when the determining determines to update the value function.
